(19) United States
(12) Patent Application Publication
(10) Pub. No.: US 2026/0044002 A1
(43) Pub. Date: Feb. 12, 2026

(54) EYE TRACKING SYSTEM AND APPARATUS FOR HEAD-MOUNTED DEVICE

(71) Applicant: Weimin NI, Hangzhou (CN)

(72) Inventors: Weimin NI, Hangzhou (CN); Cheng JIN, Hangzhou (CN); Hongquan SHEN, Hangzhou (CN)

(73) Assignee: Weimin NI, Hangzhou (CN)

(21) Appl. No.: 19/364,131

(22) Filed: Oct. 21, 2025

Related U.S. Application Data
(63) Continuation-in-part of application No. PCT/CN2025/101407, filed on Jun. 17, 2025.

(30) Foreign Application Priority Data
Jan. 6, 2025 (WO) PCT/CN2025/070727

(51) Int. Cl. G02B 27/00; G02B 1/00; G02B 27/01; G06T 5/70; G06T 7/246

(52) U.S. Cl. CPC G02B 27/0093; G02B 1/002; G02B 27/0172; G06T 5/70; G06T 7/251; G02B 2027/0138; G02B 2027/0178; G02B 2207/101; G06T 2207/20084; G06T 2207/20221; G06T 2207/30201

(57) ABSTRACT

An eye tracking system for a head-mounted device, comprises: an imaging component and an illumination component. The imaging component is configured to optically focus light from an object plane of an eye onto an image plane of an image sensor, and the illumination component is configured to optically project light from an illumination source onto the object plane of the eye. The imaging component is configured with an imaging angle-encoded mapping for optical relay-coupled imaging. The illumination component is configured with an illumination angle-encoded mapping for optical coupling projection.

### CROSS-REFERENCE TO RELATED APPLICATIONS

This application is continuation in part of International Patent Application No. PCT/CN2025/070727 with a filing date of Jan. 6, 2025, designating the United States, now pending, and further claims priority to International Patent Application No. PCT/CN2025/101407 with a filing date of Jun. 17, 2025. The content of the aforementioned applications, including any intervening amendments thereto, is incorporated herein by reference.

### TECHNICAL FIELD

This disclosure relates to a head-mounted device, and more particularly, to a system and apparatus for eye tracking.

### BACKGROUND

Optical Metasurfaces are dimensionality-reduced metamaterials, specifically two-dimensional, ultra-thin arrays of engineered nano-scatterers at sub-wavelength spacing. They arbitrarily modulate optical wavefronts by imparting a phase shift across the interface. By providing unprecedented simultaneous control over the fundamental properties of light (such as phase, amplitude, and polarization), metasurfaces aim to revolutionize optical design by replacing conventional optical elements with nearly flat, ultra-thin, and lightweight optical surfaces. Furthermore, metasurfaces enable flat photonics with structured, pixelated functional interfaces by facilitating a one-to-one correspondence between information pixels and nanostructures.

A metasurface is defined as comprising sub-wavelength structures (i.e., meta-atoms) fabricated or assembled on a substrate to impart a spatially varying optical phase delay and/or amplitude or polarization modulation onto an incident wavefront. The meta-atoms and the substrate may be composed of the same or different optical materials. The meta-atoms function by altering the phase, amplitude, and/or polarization of the incident light. The meta-atoms may have identical or differing geometries, sizes, orientations, and/or spacing. Example geometries may include rectangles, cylinders, free-form shapes, or any other suitable shape or combination of different shapes, etc. The spacing or lattice of the meta-atoms may have any suitable shape and period; the lattice may also be aperiodic, with varying or random distances between adjacent meta-atoms. In some instances, the gap between adjacent meta-atoms may be designed to have a constant gap distance. One or both sides of the substrate may be flat or curved. The metasurface and the substrate may be rigid, flexible, or curved. The geometry, size, and layout of the meta-atoms and the substrate are designed to provide the target optical functionality.

In the design methodology of metasurface devices, a phase coverage ranging from 0 to 2π may be achieved by modifying the unit cell structures, thereby establishing a phase library. After selecting the design parameters, the desired phase profile is derived based on formulas. Unit cell structures with phase responses approximating the required values are selected from the phase library to determine the distribution of each unit cell across the metasurface device. Subsequently, a simulation model is constructed using the obtained structural distribution data to analyze the resulting optical field distribution. To effectively implement various phase modulation mechanisms, common candidate materials include titanium dioxide (TiO₂), hafnium oxide (HfO₂), gallium nitride (GaN), silicon nitride (SiNₓ), and silicon carbide (SIC), which are utilized for constructing metasurfaces based on geometric phase or propagation phase principles.

In conventional manufacturing processes, the designed metasurface pattern is first created in a resist layer through deep ultraviolet (DUV) or electron beam (E-BEAM) lithography, and is then transferred to the target dielectric layer via dry etching. Nanoimprint lithography (NIL), a technique that generates nanoscale to microscale structures through mechanical pressing with the aid of heat or ultraviolet radiation, has been developed as an alternative method for low-cost, high-throughput, large-area metasurface fabrication.

With the recent advancements in AI technology, the proliferation of content creation and delivery has significantly increased in recent years. Specifically, extended reality (XR)—encompassing virtual reality (VR), augmented reality (AR), mixed reality (MR), or some combination and/or derivative such as AI glasses—has evolved alongside virtual environments (e.g., the “metaverse”). The integration of artificial intelligence in these domains may interface with applications, products, accessories, services, or some combination thereof.

Within this context, eye tracking has attracted significant attention due to its human-computer interaction method that employs natural visual behavior experience. Its multiple application areas include, but are not limited to: gaze direction/position detection, IPD (Interpupillary Distance) measurement, vergence distance estimation, biometric identification, liveness detection, and physiological state monitoring.

In AI/AR glasses applications, the configuration for eye tracking illumination and imaging is shown in FIG. 8A. The principle of eye tracking is illustrated in FIG. 8B, where light emitted from a source is reflected by the eyeball and captured by an imaging module for subsequent processing. FIG. 9 schematically shows the overall system architecture of the head-mounted device.

In AR and/or MR systems, the relatively short eyerelief combined with a wide eyebox often leads to the placement of imaging component and/or illumination sources around the eyeglass frame to provide off-axis illumination and/or imaging for the eye. Such off-axis illumination and/or imaging may be insufficient for the eye, particularly for the central region of the eye.

### SUMMARY OF THE INVENTION

In some embodiments, the disclosed eye tracking system of a head-mounted device, comprising: an imaging component, an illumination component.

The imaging component is configured to optically focus light from an object plane of the eye onto an image plane of an image sensor, and the illumination component is configured to optically project light from an illumination source onto the object plane of the eye.

In some embodiments, the imaging component is configured with an imaging angle-encoded mapping for optical relay-coupled imaging.

In some embodiments, the imaging component is configured with a predetermined incident field of view FOVᵢ and an associated exit field of view FOVᵣ. The incident field of view FOVᵢ is configured to be asymmetrically distributed relative to the principal optical axis of the imaging component. The exit field of view FOVᵣ is configured to be symmetrically distributed relative to the principal optical axis of the imaging component. The incident field of view FOVᵢ is greater than or equal to the exit field of view FOVᵣ.

In some embodiments, the angle of the principal optical axis of the imaging component is configured to reference to the region of the object plane of the eye, and to establish a uniform basis for the imaging angle-encoded mapping corresponding to the incident field of view FOVᵢ with asymmetric distribution and the associated the exit field of view FOVᵣ with symmetric distribution.

In some embodiments, the imaging angle-encoded mapping is configured to establish an optical coupling from the incident field of view FOVᵢ with asymmetric distribution to the exit field of view FOVᵣ with symmetric distribution relative to the principal optical axis of the imaging component. The imaging angle-encoded mapping is configured to encode and map an incident angle of an beam with asymmetric distribution from the object plane of the eye to a corresponding exit angle of the beam with symmetric distribution. The imaging angle-encoded mapping is characterized by an optical conjugate property. The imaging angle-encoded mapping is configured to establish a physical relationship of geometric optical imaging characteristic between the object plane and the image plane.

In some embodiments, the optical relay-coupled imaging is configured to enable image-space telecentricity with an entrance aperture near a front focal plane of object space.

In some embodiments, the illumination component is configured with an illumination angle-encoded mapping for optical coupling projection.

In some embodiments, the illumination component is configured with a predetermined incident field of illumination FOIᵢ and an associated exit field of illumination FOIᵣ.

The incident field of illumination FOIᵢ is configured to be symmetrically distributed relative to the principal optical axis of the illumination component. The associated exit field of illumination FOIᵣ is configured to be asymmetrically distributed relative to the principal optical axis of the illumination component. The incident field of illumination FOIᵢ is greater than or equal to the exit field of illumination FOIᵣ, or the incident field of illumination FOIᵢ is less than or equal to the exit field of illumination FOIᵣ.

In some embodiments, the principal optical axis of the illumination component is configured to reference to the region of the object plane of the eye, and to establish a uniform basis for the illumination angle-encoded mapping corresponding to the incident field of illumination FOIᵢ with symmetric distribution and the associated exit field of illumination FOIᵣ with asymmetric distribution.

In some embodiments, the illumination angle-encoded mapping is configured to establish an optical coupling from the incident field of illumination FOIᵢ with symmetric distribution to the exit field of illumination FOIᵣ with asymmetric distribution relative to the principal optical axis of the illumination component. The illumination angle-encoded mapping is configured to encode and map an incident angle of the beam with symmetric distribution from the illumination source to a corresponding exit angle of the beam with asymmetric distribution at the object plane of the eye. The illumination angle-encoded mapping may be characterized by an optical non-conjugate property.

The illumination angle-encoded mapping is configured to establish an optical characteristic relationship of a far field illumination irradiance profile distribution with a homogenized and/or a structured pattern on the object plane, based on the illumination source radiation model.

In some embodiments, the incident angle of the beam from the illumination source radiation model corresponds to a projected optical radiant power, and the corresponding exit angle of the beam corresponds to a projected area on the object plane of the eye.

In some embodiments, the optical characteristic relationship of the far field illumination irradiance profile distribution with the homogenized pattern is configured with a constant proportional relationship between the projected optical radiant power and the projected area on the object plane of the eye.

In some embodiments, the optical characteristic relationship of the far field illumination irradiance profile distribution with the structured pattern is configured with a corresponding profile distribution function between the projected optical radiant power and the projected area on the object plane of the eye.

In some embodiments, the eye tracking system further comprising, based on at least one of predetermined positioning location, a reflective-angle combiner is configured to direct the incident beam from the object plane of the eye to the imaging component and/or direct the exit beam from the illumination component to the object-plane region. The reflective-angle configuration creates a corresponding multi-field of view and/or multi-field of illumination, thereby expanding the field of view of the imaging component and/or the field of illumination of the illumination component.

In some embodiments, the eye tracking system further comprising, based on at least one of predetermined positioning location, a reflective-waveguide combiner configured to couple an incident beam from the object plane of the eye region into waveguide and couple out to the imaging component via total internal reflection, and/or a reflective-waveguide combiner configured to couple an exit beam from the illumination component into the waveguide and couple out to the object plane of the eye region via total internal reflection.

The reflective-waveguide configuration creates a corresponding multi-field of view and/or multi-field of illumination, thereby expanding the field of view of the imaging component and/or the field of illumination of the illumination component.

In some embodiments, the disclosed eye tracking apparatus of a head-mounted device, comprising: an imaging component and an illumination component. The imaging component comprising: a first metasurface optical element, a second metasurface optical element or a WLO optical element, and an image sensor, the imaging component is configured to optically focus light from the object plane onto the image plane. The illumination component comprising: a third metasurface optical element and an illumination source, the illumination component is configured to optically project light from the illumination source onto the object plane.

In some embodiments, the first metasurface optical element is configured to encode and map the incident angle of the beam of the object plane to an exit angle of the beam, and to optically relay the exit angle of the beam to the second metasurface optical element or the WLO optical element. The second metasurface optical element or the WLO optical element is configured to focus the beam with the exit angle onto the image plane. The third metasurface optical element is configured to encode and map the incident angle of the beam of the illumination source to the exit angle of the beam projected onto the object plane.

In some embodiments, the first metasurface optical element is configured as an imaging angle-encoded mapping metasurface optical element. The imaging angle-encoded mapping metasurface optical element is configured to encode and map each incident angle of the beam with asymmetric distribution on the object plane of the eye to a corresponding exit angle of the beam with symmetric distribution. The imaging angle-encoded mapping is characterized by an optical conjugate property. The imaging angle-encoded mapping is configured to establish an approximate physical relationship of geometric optical imaging characteristics on the object/image plane.

The second metasurface optical element is configured as a metasurface lens (metalens), or the WLO optical element is configured as a WLO imaging lens. The imaging angle-encoded mapping metasurface optical element is configured to be coaxial with the principal optical axis of the metasurface lens or the WLO imaging lens, and to enable the identical field of view with symmetric distribution.

In some embodiments, the imaging angle-encoded mapping metasurface optical element is configured to serve as an entrance aperture near a front focal plane of object space for image-space telecentricity.

In some embodiments, the third metasurface optical element is configured as an illumination angle-encoded mapping metasurface optical element. The illumination angle-encoded mapping metasurface optical element is configured to encode and map an incident angle of the beam with symmetric distribution from the illumination source to a corresponding exit angle of the beam with asymmetric distribution at the object plane of the eye. The illumination angle-encoded mapping may be characterized by an optical non-conjugate property.

The illumination angle-encoded mapping is configured to establish an optical characteristic relationship of a far field illumination irradiance profile distribution with a homogenized and/or a structured pattern on the object plane, based on the illumination source radiation model.

In some embodiments, the incident angle of the beam from the illumination source radiation model corresponds to a projected optical radiant power, and the corresponding exit angle of the beam corresponds to a projected area on the object plane of the eye.

In some embodiments, the optical characteristic relationship of the far field illumination irradiance profile distribution with the homogenized pattern is configured with a constant proportional relationship between the projected optical radiant power and the projected area on the object plane of the eye.

In some embodiments, the optical characteristic relationship of the far field illumination irradiance profile distribution with the structured pattern is configured with a corresponding profile distribution function between the projected optical radiant power and the projected area on the object plane of the eye.

In some embodiments, the eye tracking apparatus further comprising, based on at least one predetermined positioning location, a reflective-angle combiner is configured to direct the incident beam from the object plane of the eye to the imaging component and/or to direct the exit beam from the illumination component to the object plane region. The reflective-angle configuration creates a corresponding multi-field of view and/or multi-field of illumination, thereby expanding the field of view of the imaging component and/or the field of illumination of the illumination component.

In some embodiments, the eye tracking system further comprising, based on at least one of predetermined positioning location, a reflective-waveguide combiner is configured to couple an incident beam from the object plane of the eye region into waveguide and couple out to the imaging component via total internal reflection,
and/or a reflective-waveguide combiner is configured to couple an exit beam from the illumination component into the waveguide and couple out to the object plane of the eye region via total internal reflection.

The reflective-waveguide configuration creates a corresponding multi-field of view and/or multi-field of illumination, thereby expanding the field of view of the imaging component and/or the field of illumination of the illumination component.

In some embodiments, the eye tracking system of a head-mounted device further comprising: a controller is configured to synchronize the imaging component with the illumination component.

In some embodiments, the controller is configured with an imaging parameter configuration; the imaging parameter configuration, comprising:
a synchronized illumination-imaging period T;
an imaging frequency FI of the image sensor,
an exposure time TI of the image sensor,
an illumination frequency FR of the illumination source,
an activation time TR of the illumination source, and
a radiant intensity IR of the illumination source;
the imaging frequency FI of the image sensor is configured to be at least twice the illumination frequency FR of the illumination source, FI≥2*FR;
the synchronized illumination-imaging period T is configured to be 1/FR, T=1/FR;
the activation time TR of the illumination source is synchronized with and equal to the exposure time TI of the image sensor, TR=TI;
a duty cycle TR*FR is generated in response to the illumination source;
the imaging parameter configuration is adapted to maintain constant during the synchronized illumination-imaging period;
In some embodiments, the imaging parameter configuration is adapted in response to an ambient-illuminance or irradiance level measured by an ambient-light detector;
the exposure time TI of the image sensor has a linear or nonlinear negative correlation with the ambient-illuminance or irradiance level; and
the radiant intensity IR of the illumination source has a linear or nonlinear positive correlation with the ambient-illuminance or irradiance level.

In some embodiments, the controller is configured to capture a paired image frame in synchronization with alternating activation and deactivation of the illumination source during the synchronized illumination-imaging period.

In some embodiments, the controller is configured to have a motion displacement of less than a predetermined pixel shift on the image plane during the synchronized illumination-imaging period.

In some embodiments, the controller is configured to perform image fusion denoising based on the paired image with at least one of a manually engineered feature difference model, and a lightweight deep learning model.

In some embodiments, the illumination component is configured to project at least one polarization state onto the eye, the imaging component is configured to capture an image using the image sensor that is sensitive to at least one corresponding polarization state; the controller is configured to generate at least one combination of parallel and orthogonal polarization states, synchronize timing and process a polarization intensity data from the image; the polarization intensity data is configured with at least one of a cross-reference feature defined as the pattern modality of corneal polarization interference intensity, and
a dynamic-reference feature defined as the dynamic relational characteristic generated from eyeball motion;
the cross-reference feature or dynamic-reference feature is configured to characterize at least one of a 3D eye movement, and an ocular physiological state.

In some embodiments, the controller is configured with a lightweight deep learning model to perform end-to-end predictive inference for outputting at least one of the 3D eye movement, and the ocular physiological state.

In some embodiments, the controller is configured with at least one of a manually engineered feature extraction, and an autonomous high-dimensional feature extraction via a dual- or multi-channel feature fusion module in the deep learning model.

### BRIEF DESCRIPTION OF THE DRAWINGS

FIG. 1 illustrates the imaging angle-encoded mapping of the imaging component.

FIG. 2 illustrates the optical relay-coupled imaging of the imaging component.

FIG. 3 illustrates the optical path of the imaging component.

FIG. 4 illustrates the illumination angle-encoded mapping of the illumination component.

FIG. 5 illustrates the optical projection of the illumination component.

FIG. 6 illustrates the variant optical projection of the illumination component.

FIG. 7 illustrates the multi-field of view and/or the multi-field of illumination configuration.

FIG. 8A illustrates the AI/AR glasses body, and FIG. 8B illustrates the principle of the eye tracking.

FIG. 9 illustrates the overall architecture of the head-mounted device.

FIG. 10 illustrates the polarization interference intensity pattern.

### DETAILED DESCRIPTION OF PREFERRED EMBODIMENTS

The structures, geometric proportions, angles, directions, arrangement order, relative spatial positions, and other attributes shown in the drawings are illustrative in essential and are not intended to limit the scope of the claims.

The present disclosure may be embodied in various ways and should not be construed as limited to the embodiments set forth herein. Rather, these embodiments are provided to ensure that the present disclosure is thorough and complete, and will fully convey the scope of the disclosure to those skilled in the art. Like reference numerals designate like elements throughout the specification. Furthermore, in the drawings, the thicknesses, ratios, and dimensions of elements may be exaggerated or reduced for clarity of illustration.

The terminology used herein is for the purpose of describing particular embodiments only and is not intended to be limiting. As used herein, the singular forms “a,” “an,” and “the” are intended to include the plural forms as well, unless the context clearly indicates otherwise. For example, “an element” has the same meaning as “at least one element,” unless the context clearly indicates otherwise. The term “at least one” should not be construed as limiting to the quantity “one.” The terms “/” and “or” indicate “and/or.” The term “and/or” includes any and all combinations of one or more of the associated listed items. Unless otherwise defined, all terms used herein, including technical and scientific terms, have the same meanings as those commonly understood by one of ordinary skill in the art. Terms defined in commonly used dictionaries should be interpreted as having meanings consistent with their meanings in the relevant technical context and should not be interpreted in an idealized or overly formal sense unless expressly defined as such in the specification.

The term “comprising” or “including” specifies the presence of the stated features, integers, steps, operations, elements, components, or groups thereof, but does not preclude the presence or addition of one or more other features, integers, steps, operations, elements, components, or groups thereof.

In the present disclosure, the angle of a light beam (e.g., an exiting beam or an incident beam) relative to the surface normal may be defined as a positive or negative angle, depending on the angular relationship between the propagation direction of the beam and the surface normal. For example, the propagation direction may be defined as a positive angle when it is clockwise relative to the normal, and as a negative angle when it is counterclockwise relative to the normal. However, the definition in the present disclosure is not limited to this convention.

In the present disclosure, coordinates (X/Y/Z) or radial directions relative to the origin or the principal optical axis may be defined as positive or negative. For example, coordinates or radial directions are defined as positive when right/up/forward relative to the origin or principal optical axis, and negative when left/down/backward relative to the origin or principal optical axis. Coordinate systems may be equivalently transformed (e.g., between polar/spherical and Cartesian coordinate systems), though the definitions in this disclosure are not limited to such conventions.

In the present disclosure, terms used to describe optical response actions that alter light, such as “transmit,” “reflect,” “absorb,” “shield,” “block,” or similar terms referring to the processing of light, mean that a major portion (including all) of the light is transmitted, reflected, absorbed, shielded, blocked, etc. The “major portion” may be a predetermined percentage of the total light greater than 50%, such as 100%, 95%, 90%, 85%, 80%, etc., which may be determined based on the requirements of the specific application.

As used herein, words such as “slightly,” “about,” “approximately,” “substantially,” “generally,” “nearly,” and similar terms are used as terms of approximation rather than terms of degree, and are intended to account for inherent variations in measured or calculated values that would be recognized by those of ordinary skill in the art.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The term “comprising” is open-ended. As used in the claims, this term does not preclude the presence of additional structures or steps.

“Configured to”: Various units, functions, or other components may be described or claimed as being “configured to” perform one or more tasks. In such contexts, the term “configured to” indicates that the unit/function/component incorporates structures (e.g., optical path) that enable the performance of the specified task(s) during operation.

Furthermore, “configured to” may also involve adapting manufacturing processes (e.g., within semiconductor manufacturing facilities) to produce devices (e.g., photonic integrated circuits) suitable for implementing or performing one or more tasks.

“First,” “second,” etc. As used herein, these terms serve as labels for the nouns they precede and do not imply any type of ordering (e.g., spatial, temporal, logical, etc.). The terms “first” and “second” do not necessarily require that the first value must be written before the second value.

“Based On” or “Dependent On.” As used herein, these terms are used to describe one or more factors that affect a determination. These terms do not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

“Or.” When used in the claims, the term “or” is used as an inclusive or and not as an exclusive or. For example, the phrase “at least one of x, y, or z” means any one of x, y, and z, as well as any combination thereof.

### Imaging Component

Third-order Seidel aberrations induced by deviation in distribution across the off-axis wide field of view FOVᵢ at different angles of incidence (AOI), such as coma, astigmatism, and field curvature. These aberrations limit the field of view of the imaging component. In addition, the normals of the object plane and image plane exhibit the lack of parallelism. These attributes cause distortion of the physical relationship of geometric optical imaging characteristics, which in turn leads to distortion of the imaging image.

In particular, in head-mounted devices such as AR/VR glasses, structural layout constraints combined with the requirement for a wider eyebox R_{eyebox} and shorter eye relief R_{relief} lead to unacceptably low parallelism.

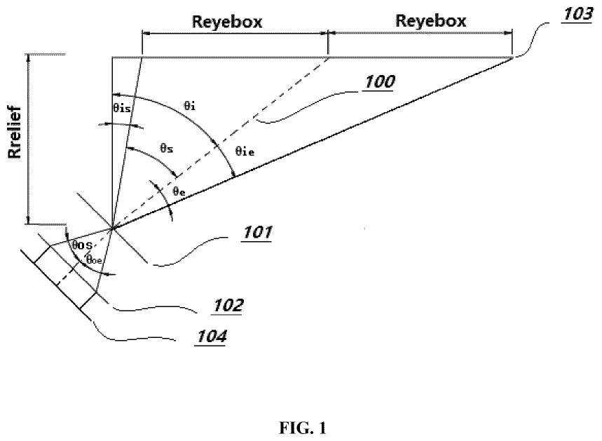

In some embodiments, as identified in FIG. 1, the imaging component comprising: principal optical axis 100, imaging angle-encoded mapping metasurface optical element 101, metasurface lens 102, object plane 103, and image plane 104.

The imaging component is configured with a predetermined incident field of view FOVᵢ with asymmetric distribution and an associated exit field of view FOVᵣ with symmetric distribution. The incident field of view FOVᵢ is configured to be asymmetrically distributed relative to the principal optical axis of the imaging component. The associated exit field of view FOVᵣ is configured to be symmetrically distributed relative to the principal optical axis of the imaging component. The incident field of view FOVᵢ is greater than or equal to the exit field of view FOVᵣ.

The principal optical axis 100 of the imaging component is configured to reference to the region of the object plane of the eye, so as to establish a uniform basis for the imaging angle-encoded mapping corresponding to the incident field of view FOVᵢ with asymmetric distribution and the associated exit field of view FOVᵣ with symmetric distribution.

The imaging angle-encoded mapping is configured to establish optical coupling between the incident field of view with asymmetric distribution and the exit field of view with symmetric distribution relative to the principal optical axis 100 of the imaging component. The imaging angle-encoded mapping metasurface optical element 101 is configured to encode and map each incident angle of the beam with asymmetric distribution from the object plane of the eye to a corresponding exit angle of the beam with symmetric distribution. The imaging angle-encoded mapping is characterized by an optical conjugate property. The imaging angle-encoded mapping is configured to establish an approximate physical relationship of geometric optical imaging characteristics on the object/image plane.

Distinguished from off-axis imaging, in which the image plane and the object plane are referenced to the principal optical axis of the imaging component, the imaging angle-encoded mapping configuration may be equivalent to coaxial or co-axial imaging.

By manipulating the wavefront phase modulation (phase profile distribution) of the imaging angle-encoded mapping metasurface optical element, the incident angle of the beam with asymmetric distribution from the object plane of the eye is encoded and mapped to the corresponding the exit angle of the beam with symmetric distribution, which are optically relayed to the image plane. This is implemented via manipulation of the wavefront phase modulation function Φ of the imaging angle-encoded mapping metasurface optical element, which has a specific phase profile distribution and is characterized by the gradient of the wavefront phase modulation function (phase gradient). In some embodiments, the wavefront phase modulation function has a first-order linear function characteristic and possesses an optical conjugate property.

An example is given where a specific wavefront phase modulation function is characterized as:

$$Φ ( r ) = - {n}_{i} * k * [ ( sin {θ}_{s} + sin {θ}_{e} ) / 2 ] * r$$

where k=2π/λ is the wave number; λ is the imaging wavelength; nᵢ is the refractive index of the incident medium (typically air).

The variable r represents the physical spatial coordinate of the wavefront phase modulation (phase profile distribution) function of the imaging angle-encoded mapping metasurface optical element (X/Y or radial dimensions as a generalized expression). The physical spatial center of the imaging angle-encoded mapping metasurface optical element is defined as the origin (r=0), and the surface normal corresponds to the reference principal optical axis of the imaging component. In some embodiments, the imaging angle-encoded mapping metasurface optical element is configured to be coaxial (or co-axial) with a symmetric distribution. In general, within the physical space of the imaging angle-encoded mapping metasurface optical element, the variable r may exist in regions of symmetric or asymmetric distribution.

FOVᵢ=[θᵢₛ, θᵢₑ] represents the original incident field of view of imaging component. In some embodiments, the principal optical axis angle of the imaging component is configured to correspond to the symmetric center of the R_{eyebox} of the object plane of the eye region 102 (with positive and negative directionalities). In some embodiments, the principal optical axis angle of the imaging component is configured as:

θᵢ=arctan[(tan θᵢₑ+tan θᵢₛ)/2](with positive and negative directionalities).

$${θ}_{s} = {θ}_{i s} - {θ}_{i}$$

$${θ}_{e} = {θ}_{i e} - {θ}_{i}$$

[θₛ, θₑ] represents the incident field of view of the imaging angle-encoded mapping metasurface optical element relative to the principal optical axis of the imaging component with an asymmetric distribution.

The angle-encoded mapping property of the imaging angle-encoded mapping metasurface optical element is characterized by coupling an asymmetric distribution incident angle φᵢ to a symmetrically distributed exit angle φₒ according to the following relationship:

$$sin {φ}_{o} = {n}_{i} / n * [ sin {φ}_{i} - ( sin {θ}_{s} + sin {θ}_{e} ) / 2 ] \qquad Equation 1$$

where n is the refractive index of the exit medium.

When an incident angle φi is coupled into the boundary angles θs and θe according to Equation 1, the coupled output, which is encoded and mapped as qo, corresponds to the exit angles θos and θoe. The exit angles θos and θoe are respectively expressed as follows:

$$sin {θ}_{o s} = - {n}_{i} / n * cos [ {θ}_{i e} + {θ}_{i {s}^{-}} 2 * {θ}_{i} ] * sin [ ( {θ}_{i e} - {θ}_{i s} ) / 2 ]$$

$$sin {θ}_{oe} = + {n}_{i} / n * cos [ {θ}_{i e} + {θ}_{i {s}^{-}} 2 * {θ}_{i} ] * sin [ ( {θ}_{i e} - {θ}_{i s} ) / 2 ]$$

Accordingly, the output coupling corresponds to the exit field of view FOVᵣ=[θₒₛ, θₒₑ] of the imaging angle-encoded mapping metasurface optical element relative to the principal optical axis of the imaging component. θₒₛ=−θₒₑ features complete symmetry relative to the principal optical axis of the imaging component. When nᵢ/n=1, θₒₛ and θₒₑ are slightly less than ±(θᵢₑ−θᵢₛ)/2, featuring a relationship in which the exit field of view approaches the relative midpoint of the original incident field of view.

For example, when FOVᵢ=[10, 70], the exit field of view FOVᵣ is approximately ±30°.

In another embodiment, for example FOVᵢ=[10, 70] and nᵢ/n=1.0, to simplify installation of the imaging component in AI/AR glasses, such as being positioned off-axis on the temple arms or nose bridge support, the principal optical axis of the imaging component is configured to be parallel to the Reyebox of the object plane of the eye region 102 (with corresponding positive and negative directionalities). The principal optical axis angle of the imaging component is configured as θᵢ=90° (with corresponding positive and negative directionalities).

$${θ}_{s} = {θ}_{i s} - {θ}_{i} = - 80 °$$

$${θ}_{e} = {θ}_{i e} - {θ}_{i} = - 20 °$$

When an incident angle φi is coupled into the boundary angles θs and θe according to Equation 1, the coupled output, which is encoded and mapped as φo, corresponds to the exit angles θos and θoe.

Accordingly, the exit field of view FOVᵣ=[θₒₛ, θₒₑ]≈[−18.75°, +18.75°] relative to the principal optical axis of the imaging component.

In another embodiment with an equivalent principle, the principal optical axis of the imaging component is configured relative to the R_{eyebox} of the object plane of the eye region 102 at θᵢ=70°.

$${θ}_{s} = {θ}_{i s} - {θ}_{i} = - 60 °$$

$${θ}_{e} = {θ}_{i e} - {θ}_{i} = 0 °$$

When an incident angle φi is coupled into the boundary angles θs and θe according to Equation 1, the coupled output, which is encoded and mapped as φo, corresponds to the exit angles θos and θoe.

Accordingly, the exit field of view FOVᵣ=[θₒₛ, θₒₑ]≈[−25.66°, +25.66°].

The principal optical axis angle θᵢ of the imaging component with a theoretically possible existence, is configured as:

$$in ( θ m - θ i ) = [ sin ( θ i s - θ i ) + sin ( θ i e - θ i ) ] / 2$$

$$θ m = arctan [ ( tan {θ}_{i e} + tan {θ}_{i s} ) / 2 ] .$$

For instance, under the conditions of FOVi=[10, 70] and ni/n=1.0,
θi may be configured as 110°.

Accordingly, the exit field of view FOVᵣ=[θₒₛ, θₒₑ]≈[−10°, +10°].

In generalized equivalence, the imaging angle-encoded mapping has an optical angular compression property: the exit field of view with symmetric distribution relative to the principal optical axis of the imaging component is less than or equal to the incident field of view with asymmetric distribution relative to the principal optical axis of the imaging component.

According to Equation 1, the relationship between the input coupling angle φᵢ and the output coupling (encoded-mapping) φₒ corresponds to the imaging angle-encoded mapping metasurface optical element, which is characterized as approximating a linear system of geometric optical imaging physical characteristics. The imaging angle-encoded mapping is configured to transform off-axis incident imaging into coaxial incident imaging relative to the principal optical axis of the imaging component.

By encoding and mapping an off-axis wide field of view FOVᵢ into a coaxial narrow field of view FOVᵣ, optical path imaging optimization is significantly improved, thereby enhancing the optical performance of the imaging component.

The imaging angle-encoded mapping is configured for optical relay-coupled imaging between the object plane of the eye and the image plane. The imaging angle-encoded mapping is characterized by an optical conjugate property.

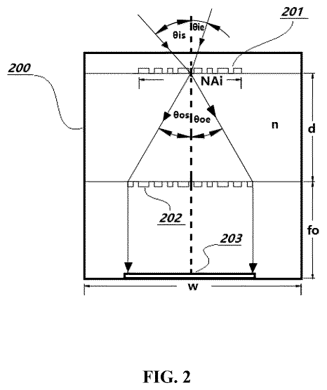

In some embodiments, as identified in FIG. 2, the imaging component 200 comprising: an optical stack configuration of imaging angle-encoded mapping metasurface optical element 201, metasurface lens (metalens) 202, and image sensor 203.

The imaging angle-encoded mapping metasurface optical element 201 and the metasurface lens (metalens) 202 are integrated in a stacked package to enable optimized optical relay-coupled imaging.

The optical relay-coupled imaging is configured to enable image-space telecentricity with an entrance aperture near a front focal plane of object space.

The imaging angle-encoded mapping metasurface optical element is configured to serve as an entrance aperture (entrance pupil) NAi for the metasurface lens on a substrate with refractive index n and thickness d correspond to an imaging wavelength.

The optical relay-coupled imaging is further configured to manipulate the incident beam, generating a telecentric exit beam focused on the image sensor plane 203.

The imaging angle-encoded mapping metasurface optical element 201 is configured to be coaxial (co-axial) with the principal optical axis of the metasurface lens 202 and to enable the identical symmetrically distributed field of view. Along the relay-coupled imaging optical path, the exit field of view FOVᵣ is configured as the field of view of the metalens 202. Based on the relay coupling by the imaging angle-encoded mapping metasurface optical element 201, the metalens 202 is configured to perform focusing by manipulating the exit field of view FOVᵣ.

In some embodiments, the entrance aperture (entrance pupil) NAi of the imaging component is configured as:

NAᵢ=W−2*d*tan(θoe)

By appropriately configuring the entrance aperture (entrance pupil) NAᵢ of the imaging component, in some examples such as numerical aperture 0.20-0.24, the corresponding f-number is 2.0-2.4, which is approximately PS/1.22λ, where the unit pixel pitch PS of the image sensor is approximately 2.2 μm. The overall package diameter W of the imaging component (generally a cylindrical radius, but also configurable as a cubic XY edge length or other surface area forms), the substrate with thickness d, and the refractive index n may be combined and adapted to various embodiment variants. For example, in AR/AI glasses where strict constraints are imposed on the overall package volume of the imaging component (e.g., within 0.008 cc), the cylindrical diameter W of the imaging component is restricted to less than 2 mm or the cubic edge length to less than 2 mm, and the thickness d is restricted to less than 1 mm.

In another example, in AR/AI glasses where strict limitations are imposed on low power consumption and thermal management of the illumination source, the optical radiant power of the illumination source is maintained at a low level while ensuring acceptable pixel brightness of image quality. In such cases, optimization of the entrance aperture (entrance pupil) NAᵢ of the imaging component, with a quadratic correlation to throughput, increases light transmission to compensate for the loss of radiant optical flux from the illumination source (linearly related to current and radiant intensity). On the other hand, in practical applications where depth-of-field requirements are imposed, restricting the entrance aperture (entrance pupil) NAᵢ of the imaging component is beneficial for approximately telecentric configurations.

In some embodiments, the diameter W of the imaging component may be slightly larger than the diameter of the metalens 202, and the diameter of the metalens 202 may be slightly larger than the image plane size H of the image sensor 203, in order to match the exit field of view FOVᵣ, i.e., the field of view of the metalens 202.

In some embodiments, a high-refractive-index dielectric material substrate n (relative to an air gap) is configured. Based on Equation (1) above, the mapping from the input coupling angle φᵢ to the output coupling angle φo depends on nᵢ/n. A high refractive index (n) enables the compression of the wide incident field of view (FOVi) to the narrow exit field of view (FOVr). For example, when nᵢ/n≈1/2.0, relay coupling may reduce FOVᵣ to approximately ±15°. For NIR/SWIR imaging wavelengths (e.g., 850/940/1030 nm; VCSEL narrowband FWHM generally <1 nm, or LED bandwidth FWHM generally 20-50 nm), refractive-index 1.0<<2.0 may be configured. This configuration also enables full manipulation to intrinsic telecentricize an exit chief ray angle (CRA), such that the CRA is adapted to approach 0° (telecentricity, e.g., less than 5° or 10°).

On the other hand, a high-index substrate may lead to the requirement of increasing the focal length of the metalens to adapt to the image sensor.

The corresponding thickness d or optical total track length (TTL) then increases. Therefore, the refractive index n and the thickness d require a reasonable trade-off and optimization.

And, a high refractive index (>3.5) of the meta-atom leads to the generation of high-order harmonics in the metasurface optical element.

In some embodiments, the refractive index difference between the meta-atom and the substrate is greater than 1.0,
the refractive index of the meta-atom is configured to be within the range of 2.0 to 3.0 (e.g., a-Si:H 2.58-3.1), and refractive index of substrate is configured to be within the range of 1.4 to 2.0 (e.g., fused silica 1.45).

In some embodiments, the metalens 202 that manipulates beam focusing is characterized by a wavefront phase modulation function (phase profile distribution):

$${Φ ( r , φ o ) = - k * [ {( r - ro )}^{2} + {fo}^{2} )}^{1 / 2} - {( {ro}^{2} + {fo}^{2} )}^{1 / 2} + r * sin φ o$$

$$ro = fo * tan ( ϕ cra )$$

where fo is focal length of metalens. φcra is exit chief ray angle to focal plane relative to incident angle φo at metalens. r is the physical spatial variable (the radial coordinate from the metalens center).

In some embodiments, a phase engineering optimization is applied to the overlap of the phase profile distribution associated with the angle of incidence (AOI) on the metalens (e.g. in 5° localized optical zoning).

The metalens 202, enabling the phase engineering optimization, is characterized by a wavefront phase modulation function (phase profile distribution):

$$Φ ( r ) = k * \sum An * {( r / R )}^{2 n} , n = [ 1 , 6 ]$$

where R is the physical radius of the metalens 202; An denotes the coefficient of the n-th term to be optimized in the phase modulation function; and 2n denotes the order in the Taylor expansion of the phase modulation function. Because the phase profile is radially symmetric, only even terms are considered.

In other embodiments, the wavefront phase modulation function (phase profile distribution) of the metalens 202 is configured with a quadratic phase profile (quadratic phase):

$$Φ ( r ) = - k * {r}^{2} / ( 2 * fo ) ,$$

featuring a virtual aperture characteristic and a displacement with an offset of fo*sin(φo).

The entrance aperture (entrance pupil) NAᵢ of the imaging component is configured to be located near the front focal plane on the object space of the metalens 202 to enable image-space telecentricity. This configuration facilitates limit the chief ray angle (CRA), thereby reducing the sensitivity of the point spread function (PSF), the modulation transfer function (MTF), and the relative illumination (RI) to the exit field of view FOVᵣ. In some embodiments, the metalens 202 is configured to focus the exit chief ray angle with image-space telecentricity, and the Strehl ratio (SR) on the focal plane is greater than 0.8.

For a given FOVr and substrate with refractive index n, the metalens may be characterized by independent parameter: numerical aperture NA (i.e. NAi, d≈fo).

Maximization of the entrance aperture (entrance pupil) NAᵢ versus focal-plane spatial resolution MTF is a constrained relationship associated with the exit field of view FOVᵣ.

In some embodiments, under the FOVᵣ range, a predetermined focal-plane spatial resolution MTF (e.g., MTF≥1/e @ Nyquist, where the Nyquist spatial cutoff frequency is 0.5/PS) or a predetermined full-depth-of-field spatial resolution (minimum acceptable MTF within the depth-of-field range, MTF≥1/e @ Nyquist/2, or MTF≥1/e @ Nyquist/4) is configured, and maximizing NAᵢ is the optimization objective. Engineering optimization is then performed on key parameters including the target even-order coefficients of the wavefront phase modulation function of the metalens 202, the substrate with refractive index n and thickness d (less than 1 mm and approximately fo), and the focal length fₒ (e.g., 0.5-1 mm).

In other embodiments, with a predetermined entrance aperture (entrance pupil) NAᵢ under the FOVᵣ range, maximizing focal-plane spatial resolution or a predetermined full-depth-of-field MTF is taken as the optimization objective, and engineering optimization is performed for the target even-order coefficients of the wavefront phase modulation function of the metalens 202, the substrate with refractive index n and thickness d of, and the focal length fₒ.

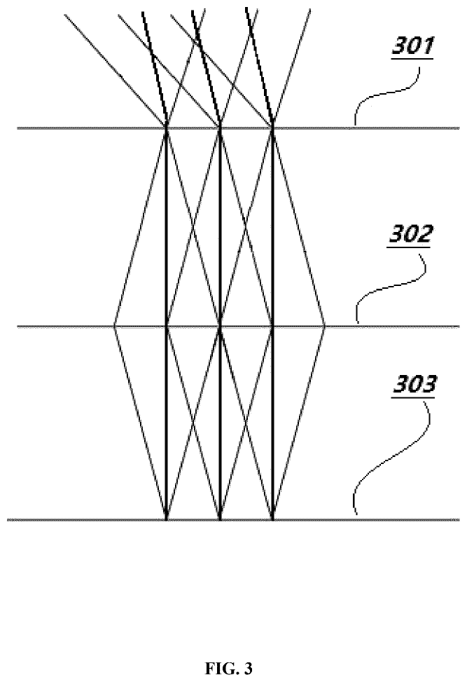

As identified in FIG. 3, the relay-coupled imaging optical path is formed by the imaging angle-encoded mapping metasurface optical element 301, the metalens 302, and the image plane 303.

In some embodiments, the metalens 302 or the imaging angle-encoded mapping metasurface optical element 301 is configured with subwavelength nanostructures that modulate transmitted light based on propagation phase (TE and/or TM waves imparting the required phase shift). These include, but are not limited to, meta-atoms such as nanocubes, nanocylinders, and other nanopillars with optically isotropic cross-sections. In some embodiments, a nanopillar subwavelength nanostructure is polarization-insensitive and has a relatively simple, manufacturable geometry. The unit-cell structure parameters of the nanopillar meta-atom include meta-atom diameter (e.g. 50/100-350 nm), period (e.g. 400 nm), and height (e.g. 800 nm). The meta-atom diameter at position r may be determined from the desired transmittance and the phase delay given by the wavefront phase modulation function Φ(r) (phase profile distribution).

In some embodiments, the metalens 302 or the imaging angle-encoded mapping metasurface optical element 301 may be configured with subwavelength nanostructures that modulate incident light based on the geometric phase (Pancharatnam-Berry phase). By simply rotating anisotropic nanostructures to a predetermined angle, a phase retardation equal to twice the predetermined angle is introduced to the cross-polarized component of circularly polarized incident light.

In some embodiments, the imaging angle-encoded mapping metasurface optical element 301 is configured as a subwavelength nano-diffraction grating structure with a linear phase gradient.

The imaging component formed by relay coupling of the imaging angle-encoded mapping metasurface optical element and the metalens is characterized by optical properties that include, but are not limited to, the following:
(i) Relative illumination (RI) shows no attenuation, with illumination from the on-axis beam being almost identical to illumination at the field edge. In some embodiments, RI is greater than 90%.
(ii) Highly selective filtering of stray light by AOI is enabled. In some embodiments, stray light with an AOI greater than the incident field of view FOVᵢ is selectively filtered, and the SNR is improved by an order of magnitude.
(iii) The crosstalk between adjacent pixels is prevented. In some embodiments, eliminating crosstalk effects reduces the requirement for DTI/FDTI.
(iv) The CRA is configured to be telecentric, ensuring perpendicular incidence onto the image sensor. In some embodiments, the CRA requirement for the image sensor has been eliminated.
(v) The microlens of pixel is not required to collect and focus beam without AOI. In some embodiments, microlens removal is supported.
(vi) Aberration and MTF resolution at the center and edge are approximate. In some embodiments, at the incident field of view FOVᵢ greater than 90°, the edge MTF is greater than 50% @Nyquist/4; at the incident field of view FOVᵢ of 60°, the edge MTF is greater than 50% @Nyquist/2.

Distortion is minimized. In some embodiments, at the incident field of view FOVᵢ greater than 90°, distortion is less than 2%.

In some embodiments, the monolithic metalens configured for optimal beam focusing efficiency and transmission efficiency, such that both the beam focusing efficiency and optical energy utilization are greater than 80%.

A wide incident field of view FOVᵢ is supported. In some embodiments, the incident field of view exceeds 90°.

Although clearly distinguished from traditional WLO imaging lens focusing methods (e.g., manufacturing processes based on semiconductor materials such as etching/lithography, imprinting, inlaying, UV curing, cutting, and packaging), in some embodiment implementations, conventional WLO imaging lens is still optionally adopted.

In yet other embodiments, conventional optical image quality improvement methods are equivalently applied to the imaging component, such as AR antireflection/reduction coatings and narrow-band filters (NB-filter) for NIR/SWIR imaging wavelengths. These methods are known to be severely limited by AOI. However, due to the imaging angle-encoded mapping, the exit field of view FOVᵣ minimizes AOI, alleviating such limitations.

Based on the high tunability of metasurface optical elements in manipulating optical properties such as polarization, wavelength, and AOI, the metasurface optical element is configured to enable multiplexing functions to perform various optical modulation according to application requirements.

In some embodiments, the metalens or the imaging angle-encoded mapping metasurface optical element is configured to feature different modulation behaviors, such as dependence on AOI, phase delay, polarization modulation, and spectral response.

The metalens or the imaging angle-encoded mapping metasurface optical element is also configured with different dielectric materials and/or subwavelength nanostructure constructions, thereby tuning sensitivity to incident angle of the beam, wavelength, and polarization. For example, in some embodiments, subwavelength rectangular block structures with anisotropic cross-sections, such as nanobricks/nanoblocks, are configured.

By tuning their length, width, and height, orientation angle (anisotropy), phase responses in two orthogonal polarization directions are independently manipulated. These are core unit cells for polarization-dependent metasurfaces.

In some embodiments, the metalens or the imaging angle-encoded mapping metasurface optical element is sensitive or responsive at specific SWIR/NIR imaging wavelengths and/or incident field of view ranges, while non-imaging wavelengths and/or non-imaging AOI are reflected, absorbed, shielded, or blocked so as not to generate a substantial response. This suppresses anisotropic stray light and non-imaging wavelengths from the background environment, thereby improving the optical performance of the imaging component.

In some embodiments, the metalens or the imaging angle-encoded mapping metasurface optical element is sensitive or responsive to specific imaging polarization states, while non-imaging polarization states are reflected, absorbed, shielded, or blocked so as not to generate a substantial response.

In some embodiments, the metalens or the imaging angle-encoded mapping metasurface optical element enables an imaging polarization state corresponding to a specific illumination polarization state (for example, VCSEL radiation essentially responding to an approximately linear polarization direction) in the orthogonal polarization direction, thereby filtering illumination incident light of non-imaging polarization states.

In some embodiments, the surface of the image sensor is configured with a polarization metasurface optical element (e.g., based on absorptive or reflective type meta-atom material and orientation structures to form linear polarization and phase delay). This constructs a physically isolated 2*2 pixel polarization imaging mode, including but not limited to 0+90+45/135+LCP/RCP unit element combinations, to generate multi-polarization state combination imaging.

The polarization dielectric materials may be configured with aluminum (Al), titanium dioxide (TiO₂), aluminum oxide (Al₂O₃), tungsten (W), silicon dioxide (SiO₂), silicon (Si), silicon nitride (Si₃N₄), and amorphous silicon (a-Si).

The above examples are provided solely for explanatory purposes and are not intended to be exclusive or limiting. Equivalent generalized variants may exist and may be implemented.

Furthermore, the image sensor has a key impact on image quality. In some embodiments, the image sensor may be configured as a quantum-dot (QD) image sensor or a silicon-based back-side-illuminated (BSI) CMOS image sensor. The process architecture of the QD image sensor is similar to that of the BSI CMOS image sensor, in which a thin film of quantum-dot material replaces silicon as the photosensitive layer and is integrated above the readout circuit (ROIC) by printing or spin-coating. The architecture enables scalability and mass production, provides higher photoelectric quantum efficiency (QE) at SWIR/NIR imaging wavelengths, process compatibility, tunable spectral response, wide dynamic range, a thin form factor, and support for an electronic global shutter.

In some embodiments, the image sensor may also be configured as a dynamic event image sensor, which asynchronously detects pixel-level luminance-change events as outputs.

In some embodiments, one or more image sensors may be configured, such as a CMOS image sensor, a defocus image sensor, a light-field sensor, or a single-photon avalanche diode (SPAD), and/or, in certain embodiments, a non-imaging sensor such as a self-mixing interferometry (SMI) sensor. In some embodiments, a combined VCSEL/SMI photonic integrated circuit (PIC) may simultaneously serve as both the illumination source and an eye tracking sensor, enabling detection of the eye-movement direction and speed via Doppler shift.

AR/AI glasses face complex ambient-light conditions. The imaging component is typically exposed outdoors. Due to power-consumption limits, the illumination source may generate irradiance on the eye surface that is lower than the surrounding ambient illuminance. Ambient light comprising multi-directional, multi-reflection stray light that may fall within the AOI of the imaging component. In addition, high outdoor temperatures may increase imaging noise.

In some embodiments, the improvement comprising: an ambient-light detector, such as an ambient-light sensor (ALS) (optionally integrated with the image sensor); and an electrochromic direct filter.

In some embodiments, the eye tracking system of a head-mounted device further comprising: a controller is configured to synchronize the imaging component with the illumination component.

In some embodiments, the controller is configured with an imaging parameter configuration; the imaging parameter configuration, comprising:
a synchronized illumination-imaging period T;
an imaging frequency FI of the image sensor,
an exposure time TI of the image sensor,
an illumination frequency FR of the illumination source,
an activation time TR of the illumination source, and
a radiant intensity IR of the illumination source.

The imaging frequency FI (frame rate) of the image sensor is configured to be at least twice the illumination frequency FR of the illumination source, FI≥2*FR.

The synchronized illumination-imaging period is configured to be 1/FR.

The activation time TR of the illumination source is synchronized with and equal to the exposure time TI of the image sensor (TR=TI).

The duty cycle TR*FR is generated in response to the configuration of the illumination source.

The image sensor is configured to capture paired image frame in synchronization with alternating activation and deactivation of the illumination source during the synchronized illumination-imaging period.

In some embodiments, the imaging parameter configuration further comprises: low conversion gain (LCG) or high conversion gain (HCG) with single-exposure linear output mode.

In some embodiments, the imaging parameter configuration further comprises: dual conversion gain (DCG) with single-exposure HDR output mode, which is enabled by sampling the identical photo-generated charge twice with different conversion gains (LCG and HCG) per pixel.

The associated imaging parameter configuration is adapted to maintain constant during the synchronized illumination-imaging period.

The associated imaging parameter configuration is adapted in response to the ambient-illuminance/irradiance level measured by the ambient-light detector.

The image sensor generates continuous, paired image frame responses temporally, in synchronization with the alternating activation and deactivation of the illumination source.

In some instances of physical implementation, the controller is configured to operate in master mode or slave mode.

In master mode, the controller generates an external frame synchronization and exposure trigger signal, in slave mode, it utilizes the image sensor's internal frame synchronization and exposure strobe signal.

The signal is configured to generate a logic timing output to the current/flash driver for pulse-driven alternating activation and deactivation illumination.

The exposure time TI of image sensor is configured to respond to ambient-illuminance/irradiance with a linear or nonlinear negative (inverse) correlation, and/or the radiant intensity IR of the illumination source is configured to respond to ambient-illuminance/irradiance with a linear or nonlinear positive correlation. Because the incident angle, wavelength, and illuminance/irradiance of ambient light possess high uncertainty and randomness, pixel-wise registration/alignment of image frames may not be determined based on image correlation.

A motion displacement is configured to be less than a predetermined pixel shift MP on the image plane during the synchronized illumination-imaging period. In some embodiments, MP is configured as 1-2 pixels; in other embodiments, MP is within a range including but not limited to sub-pixel precision of 0.5-4 pixels. Based on the eyeball radius R_{eye} and the angular velocity ω of the eye tracking, the constraint of motion displacement is:

$${R}_{eye} * ω * T <= MP / PR$$

The product TI*IR, under the constraint of constant irradiance at the eye surface, is configured for joint optimization to improve image quality, including motion blur, pixel shift, and ambient-light incident noise. PR defines the predetermined pixel spatial resolution across R_{eyebox} region at a specified exit pupil distance R_{relief}. In some embodiments, PR is configured as 10-20 pixels/mm; in other embodiments, PR is within a range including but not limited to 5-40 pixels/mm.

The paired image frame generated by the image sensor, is synchronized with the alternating activation and deactivation of the illumination source.

Under identical imaging parameter configuration, a mixed signal-and-noise image frame Im is generated during illumination activation, and a noise image frame (incident stray light) In is generated during illumination deactivation.

The corresponding frame difference enables the suppression of background ambient light.

Physically, the differential architecture separates and eliminates the low-frequency and fixed-pattern noise image (which are temporally highly correlated) from the mixed image.

Furthermore, in some embodiments, the controller is configured with a lightweight deep learning model to perform end-to-end predictive inference for image fusion denoising based on the paired image.

In some instances, a dual-channel feature-difference encoder-decoder network architecture is configured to perform image fusion for denoising with spatiotemporal correlation.

The dual-channel feature-difference encoder-decoder network architecture, comprising:
i. Encoder Module:
(i) A dual-channel shared-weight encoder is employed because the input paired images share identical dimensions and similar noise characteristics. This architecture ensures that both inputs are mapped into the identical feature space, thereby establishing the foundation for feature-wise difference operations.
(ii) The encoder consists of several convolutional layers that progressively downsample to extract features. The mixed image Im and noise image In are input into the dual-channel shared-weight encoder, generating mixed image features Fm and noise image features Fn.
(iii) The backbone options, comprising:
   lightweight: The initial stages of ResNet or MobileNet.
   high-performance: A U-Net or VGG-style encoder.
   advanced: The patch embedding layers of a Vision Transformer (ViT).
ii. Differential Convolution Module: Computes the difference between the mixed image features and the noise image features to extract features of the original image. The features from the two encoders are processed via differential convolutional layers by concatenating them, then generating differential features Diff (Fm,Fn). In some instances, the differential convolutional layers can be configured to include:
(i) Basic Differential Convolutional Layer: Computes differential features between the mixed image features and the noise image features.
(ii) Attention-Guided Differential Convolutional Layer: Uses attention mechanisms to focus on important differential regions.
(iii) Multi-Scale Differential Convolutional Layer: Computes and processes differential features at different scales.
(iv) Residual Differential Convolutional Layer: Combines residual learning with differential computation.

In some instances, pixel-wise registration/alignment of paired image is enabled by dynamic convolutional differencing based on the relationship between F_Im and F_In, the parameters of the convolution kernel are dynamically generated to apply an affine transformation to F_In before differencing it with F_Im, thereby achieving implicit feature registration and alignment.

In other instances, a feature alignment module based on lightweight deformable convolution may be inserted prior to the differential convolution module to calibrate F_In and align it with F_Im.

In other instances, a feature alignment module based on optical flow-guidance may be configured to achieve implicit feature registration and alignment.
iii. Decoder Module: A multi-scale fusion decoder decodes the differential features Diff(Fm,Fn) into the output original image Io. It consists of upsampling and convolutional layers that upsample the differential features to the original image dimensions.

In some instances, the loss function can adapt to L1/L2 losses and perceptual losses such as:
Primary reconstruction loss,
Physical consistency loss,
Residual consistency loss,
Noise consistency loss,
Attention sparsity constraint,
Output smoothness constraint, etc.

The dual-channel feature-difference encoder-decoder network architecture operates on a core principle: transitioning from pixel-wise to feature-wise difference. This fundamental shift significantly boosts the model's expressive power and robustness.

The dual-channel feature-difference encoder-decoder network architecture features explicit modeling of interpretable physical relationships to improve denoising accuracy, multi-scale feature fusion, processing features at different scales, and preserving original image details.

In some embodiments, the residual learning denoising model may be applied, wherein a fundamental residual denoising network architecture—typically a CNN, such as the encoder-decoder structure of U-Net—serves as the backbone network to learn the residual mapping R(x) from data paired images.
1. Data paired images: (Im, In)
2. Input Im into the network
3. The network outputs the residual R(Im)
4. Loss computation:

$$Ground - truth signal : ni = Im - In$$

$$Loss function ( e . g . , L 2 loss ) : Loss = {‖ R ( Im ) - ni ‖}^{2}$$

5. The network weights R are updated through backpropagation and optimizer algorithms, progressively aligning the output R(x) with the ground-truth signal ni.

The field of machine/deep learning is currently undergoing a paradigm shift from supervised learning toward self-supervised and unsupervised paradigms, with the goal of eliminating the reliance on paired ‘noisy-clean’ image data. This shift is driving groundbreaking research across various domains.

In some embodiments, self-supervised or unsupervised learning is achieved by leveraging the paired image. Specifically, the noisy image (In) serves as built-in supervisory signal to disentangle and recover the signal image from the mixed image (Im).

In some embodiments, under the predetermined motion displacement conditions, unpaired learning models such as the exemplary Noise2Noise denoising architecture may also be employed.

In other implementations, deep learning models based on the Retinex principle may be employed, typically configured with U-Net architectures. The fundamental principle involves a reflectance consistency constraint in the loss function for reflectance components corresponding to two distinct illumination components-specifically, the reflectance images decomposed from images with different illumination components Im and In should converge toward similarity.

Retinex-based deep learning approaches enforce physically plausible decomposition via a reflectance consistency constraint. Despite differing illumination conditions in input images Im and In, their corresponding reflectance components derived from decomposition should maintain similarity, as these components capture the intrinsic physical properties of the scene. This constraint forces the network to learn illumination-invariant feature representations.

In some implementations, the model may be an explicit regularization model based on feature-difference, or an implicit prior regularization model.

Considering computational complexity and power consumption, a manually engineered feature registration and difference model approaches may also be configured for image fusion-based denoising.

The spatiotemporal correlation-based convolutional difference method, including: correlation-based convolutional registration and difference steps for the paired image (Im and In).

The optical flow feature-based alignment difference method, including optical flow registration and difference steps for the paired image (Im and In).

The requency domain feature-based differential method, such as Fourier phase correlation-based registration and difference methods for the paired image (Im and In).

The method comprise the following steps:

Fourier transform computation, cross-power spectrum calculation, phase correlation determination, maximum correlation position identification (displacement estimation), cyclic shift computation and displacement alignment, frequency-domain difference calculation, and inverse Fourier transform reconstruction.

In other instances, Fourier transforms may also be replaced by wavelet transforms.

Under the motion displacement constraints, the stray light incidence on the ocular surface manifests as random model noise (mid-high frequency components) and localized fixed pattern noise (low frequency components), enabling the application of diverse filter types for signal enhancement.

In some embodiments, a UV/IR high-reflectance thin-film coating is adapted for the world-facing side of a waveguide or lens to block and filter external ambient light in outdoor sunlight or artificial-light exposure scenarios. UV and IR radiation may harm ocular bio-safety: UV causes photochemical damage, and IR causes thermal-absorption damage. The coating also functions as a filter to improve the optical SNR of the imaging component.

Advanced thin-film deposition and materials-science techniques are configured to integrate one or more IR filters, one or more antireflection (AR) films, and/or one or more anti-scratch coatings/layers into the optical elements of the imaging component and the glasses. For example, vacuum deposition, spin-coating, and dip-coating provide consistent, high-quality coatings in mass production. In some embodiments, IR-absorbing compounds and/or dyes are embedded in the glasses material. In some embodiments, thin-film interference filters are configured to operate by reflecting specific IR wavelengths while transmitting visible light, and are applied to the surfaces of materials in the imaging component and the glasses. In embodiments employing AR films, the AR film is configured as a multilayer stack coated by vacuum deposition. In embodiments employing anti-scratch coatings, the coating is configured as a hard, durable, silica-based polymer-like layer that protects underlying functional coatings from minor wear and scratches. These coatings are configured to enable radiation protection, reduce glare, and improve resistance to daily wear, thereby maintaining integrity.

The foregoing imaging-component examples are provided only for principle explanation and are not intended to be exclusive or limiting. Equivalent generalized variants may exist and may be implemented.

### Illumination Component

Non-uniform irradiance on the object plane, caused by the off-axis geometry and the lack of parallelism between the object and illumination source plane normals, results in non-uniform relative illumination (RI) of the captured image.

This may be unacceptable in head-mounted devices such as AR/AI glasses, where structural layout constraints combined with the need for a wider eyebox R_{eyebox} and shorter eyerelief R_{relief} result in excessively low parallelism.

Distinguished from off-axis illumination, in which the illumination source and the object plane are referenced to the principal optical axis of the illumination component, the illumination angle-encoded mapping configuration may be equivalent to coaxial or co-axial illumination.

The illumination component is configured with an illumination angle-encoded mapping metasurface optical element that enables the incident field of illumination FOIᵢ with symmetric distribution and the associated exit field of illumination FOIᵣ with asymmetric distribution. The illumination angle-encoded mapping enables projection optical coupling between the illumination source and the object plane of the eye.

The incident field of illumination FOIᵢ is configured as a symmetric distribution relative to the principal optical axis of the illumination component, while the associated FOIᵣ is configured as an asymmetric distribution. Depending on the illumination source, FOIᵢ may be greater than or equal to FOIᵣ (e.g., LED/microLED), and FOIᵢ may be less than or equal to FOIᵣ (e.g., VCSEL).

The principal optical axis of the illumination component is referenced to the region of the object plane of the eye, which enables a uniform basis for illumination angle-encoded mapping between the symmetric incident field of illumination FOIᵢ and the associated asymmetric exit field of illumination FOIᵣ.

The illumination angle-encoded mapping is configured to establish optical coupling between the incident field of illumination with symmetric distribution and the exit field of illumination with asymmetric distribution relative to the principal optical axis of the illumination component.

The illumination angle-encoded mapping metasurface optical element is configured to encode the incident angle of the beam with symmetric distribution from the illumination source into the corresponding exit angle of the beam with asymmetric distribution at the object plane of the eye. The illumination angle-encoded mapping may be characterized by an optical non-conjugate property. On the illumination-source/object plane, the illumination angle-encoded mapping is configured to establish, based on the illumination-source radiation model, an optical characteristic relationship of the far field illumination radiation profile distribution with approximately homogenized irradiance.

The illumination source may be spherical or plane wave source model. In some embodiments, the illumination source may be configured as an LED or a VCSEL. Based on a spherical-wave point-source model, the illumination beam is projected by means of the illumination angle-encoded mapping onto the object plane, thereby generating a far field illumination radiation profile distribution with approximately homogenized irradiance within the R_{eyebox} region of the object plane of the eye.

In some embodiments, the LED illumination source may be configured with a full width at half maximum (FWHM) of approximately ±60° in its surface-normal incident field of illumination (FOIi).

In other embodiments, the VCSEL illumination source can be configured with a full width at half maximum (FWHM) of approximately ±(10-30)° or narrower in its surface-normal incident field of illumination (FOIi).

These embodiments are not limiting, and the surface-normal incident field of illumination FOIᵢ may be wider or narrower. In addition, in some embodiments, the illumination source may be configured to operate jointly with various types of illumination sources and optical combiners, including but not limited to a homogenizer, collimator, diffuser, deflector, and other beam-shaping elements or their combinations.

By manipulating the wavefront phase modulation (phase profile distribution) of the illumination angle-encoded mapping metasurface optical element, the mapping generates the incident field of illumination with symmetric distribution from the illumination source and projects the corresponding exit field of illumination with asymmetric distribution onto the eye object-plane region.

By manipulating the wavefront phase modulation function Φ of the illumination angle-encoded mapping metasurface optical element, a specific phase profile distribution is formed and characterized by the gradient of the wavefront phase modulation function (phase gradient).

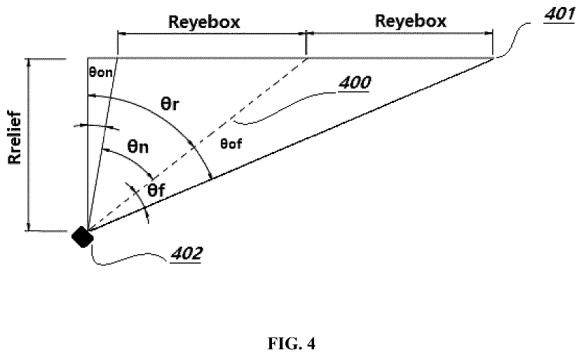

In some embodiments, as shown in FIG. 4, the principal optical axis of the illumination component is labeled as 400, the illumination angle-encoded mapping metasurface optical element is labeled as 401, and the eye object-plane region is labeled as 402.

FOIᵢ=[θᵢₙ, θ_{if}] denotes the original incident field of illumination of the illumination source. For example, the FWHM of the LED may be approximately ±60°, and the FWHM of the VCSEL may be approximately ±(10-30°) or narrower.

The distribution is configured symmetrically about the principal optical axis of the illumination component, where θin=−θif.

The exit field of illumination of the illumination source is configured as FOIᵣ=[θₒₙ, θ_{of}]. In some embodiments, FOIr is configured to be greater than or equal to the incident field of view FOVᵢ of the imaging component. In some embodiments, the principal optical axis 400 of the illumination component is aligned with the symmetric center of the R_{eyebox} in the eye object-plane region 402 (with corresponding positive and negative directions). In some embodiments, the principal optical axis angle is configured as:

$${θ}_{r} = arc tan [ ( tan {θ}_{on} + tan {θ}_{of} ) / 2 ] \text{} ( with corresponding positive and negative directions ) .$$

$$Define {θ}_{n} = {θ}_{on} - {θ}_{r} and {θ}_{f} = {θ}_{of} - {θ}_{r} .$$

Then [θₙ, θ_{f}] represents the exit field of illumination of the illumination angle-encoded mapping metasurface optical element with the asymmetric distribution relative to the principal optical axis of the illumination component.

The illumination angle-encoded mapping metasurface optical element is characterized by coupling an incident angle φᵢ with symmetric distribution to an exit angle φₒ with asymmetric distribution, according to the following relationship:

$$sin {φ}_{o} = 1 / n * [ {n}_{i} sin {φ}_{i} + 1 / k * {Φ}^{′} ( r ) ]$$

or equivalently,

$$Ko - Ki = {Φ}^{′} ( r )$$

$$Ki = k * ni * sin ( {φ}_{i} ) and Ko = k * n * sin ( φ o )$$

where Ki, Ko represent the wave vectors of the incident and exit wave directions on the plane of the illumination angle-encoded mapping metasurface optical element. nᵢ/n is the refractive index ratio of the incident and exit media, typically air, with nᵢ/n=1.0.

When the incident angle φi is coupled into the boundary angles θin and θif according to Equation above, the coupled output, which is encoded and mapped as the exit angle φo, corresponds to the boundary angles θn and θf.

Accordingly, the exit field of illumination is FOIᵣ=[θₒₙ, θ_{of}].

Based on the predetermined boundary conditions of the incident field of illumination and the illumination source radiation model on the eye object-plane region (surface area), the illumination angle-encoded mapping metasurface optical element is configured to manipulate the incident angle of the beam from the illumination source and map it to the corresponding exit angle of the beam projected onto the R_{eyebox} of the eye object-plane region (surface area), thereby generating the far field illumination profile distribution with homogenized irradiance. Based on this principle, a specific example with Lambertian radiator is described as follows:

$$E ( φ o ) = d Ω ( φ i ) / dS ( φ o ) * cos {θ}_{r} \qquad Eq . 2$$

where Ω(φi) and E(φo) respectively represent the radiant power and the resulting irradiance on the eye object plane. Specifically, Ω(φi) defines the radiant power from the illumination source by the incident angle of the beam φi, while E(φo) is the irradiance on the eye object plane generated by the corresponding exit angle of the beam φo.

S(φo) denotes the corresponding surface area on the eye object-plane region by the corresponding exit angle of the beam φo.

Io denotes the surface normal radiant intensity of the illumination source.

$$Ω ( φ i ) = 2 π * {I}_{o} * \int cos θsinθdθ θ = [ 0 , φ i ]$$

When φi=θᵢₙ or φ_{if}, the incident angle of the beam of the illumination source radiation model projects onto the R_{eyebox} boundary of the eye object-plane region at the corresponding exit angle of the beam φo=θn or θf.

Under the condition that any incident angle of the beam φi and the boundary incident angle of the beam θᵢₙ or θ_{if} project corresponding radiant powers (Ω(φi) and Ω(θᵢₙ) or Ω(θ_{if})) onto corresponding areas of the eye object-plane region (S(φₒ) and S(θₙ) or S(θ_{f})) at the corresponding exit angle of the beam, homogenized irradiance in the far field illumination profile distribution is generated when

$$Ω ( φ i ) / S ( φ o ) = Ω ( {θ}_{in} ) / S ( {θ}_{n} ) \qquad Eq . 3$$

$$or equivalently ,$$

$$Ω ( φ i ) / S ( φ o ) = Ω ( {θ}_{if} ) / S ( {θ}_{f} )$$

Equation 3 may be interpreted as a constant proportional relationship between the radiant power projected at a given incident angle of the beam and the surface area on the eye object-plane region at a corresponding exit angle of the beam. This constant relationship generates the condition for homogenized irradiance in the far field illumination profile distribution.

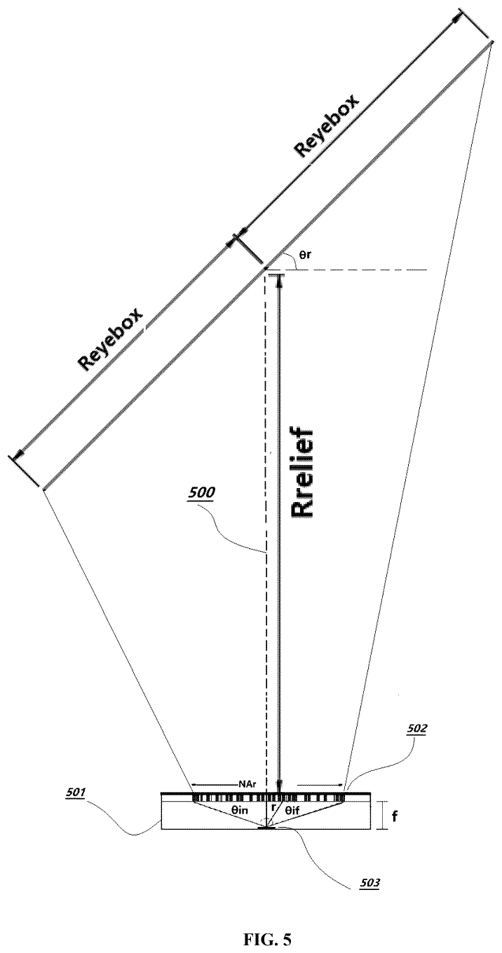

As shown in FIG. 5, the principal optical axis of the illumination component is labeled as 500, the illumination component is labeled as 501, the illumination angle-encoded mapping metasurface optical element is labeled as 502, and the illumination source is labeled as 503. In some embodiments, with the LED illumination source radiation model, projection by means of the illumination angle-encoded mapping metasurface optical element onto the object plane generates the homogenized far field irradiance profile on R_{eyebox}. The illumination-source radiation model is configured as a Lambertian radiator with an intensity profile distribution relative to the surface normal.

According to Equation 3, a simplified expression is as follows:

$$S ( φ o ) / S ( {θ}_{n} ) = {( sin φ i / sin {θ}_{in} )}^{2}$$

$$or equivalently ,$$

$$S ( φ o ) / S ( {θ}_{f} ) = {( sin φ i / sin {θ}_{if} )}^{2}$$

The far field projected surface area S(φo) may be represented by a composite function R(r) in the generalized X/Y or radial dimension.

A simplified expression in terms of the radial dimension for R(r) is as follows:

$$R ( r ) / {R}_{eyebox} = sin φ i / sin θ in$$

$$or$$

$$R ( r ) / {R}_{eyebox} = sin φ i / sin θ if$$

In some embodiments, the illumination angle-encoded mapping metasurface optical element may be characterized by a wavefront phase modulation function with high-order nonlinearity and optical non-conjugation.

Based on the above principle, to generate the homogenized far field irradiance profile, the illumination angle-encoded mapping manipulates the incident angle of the beam from the illumination source, mapping it to the corresponding exit angle of the beam that projects onto the Reyebox within the eye object-plane region.

A specific wavefront phase modulation function gradient (phase gradient) may be characterized as:

$${Φ}^{′} ( r ) = k * \{ [ R ( r ) cos {θ}_{r} - r ] {/ [ {( R ( r ) cos {θ}_{r} - r )}^{2} + {( {R}_{relief} / cos {θ}_{r} + R ( r ) * sin {θ}_{r} )}^{2} ]}^{1 / 2} - sin ( arctan ( r / f ) ) \} \qquad Eq . 4$$

$$where R ( r ) = {R}_{eyebox} / sin {θ}_{{in}^{*}} sin ( arctan ( r / f ) ) or R ( r ) = {R}_{eyebox} / sin {θ}_{if} * sin ( arctan ( r / f ) ) .$$

$$Equivalently ,$$

$${Φ}^{′} ( r ) = k * \{ [ R ( r ) cos {θ}_{r} - r ] {/ [ {( R ( r ) cos {θ}_{r} - r )}^{2} + {( {R}_{relief} / cos {θ}_{r} + R ( r ) * sin {θ}_{r} )}^{2} ]}^{1 / 2} - f ( r ) \}$$

$$R ( r ) = {R}_{eyebox} / sin {θ}_{in} * f ( r )$$

$$or R ( r ) = {R}_{eyebox} / sin {θ}_{if} * f ( r )$$

$$f ( r ) = r / {( {r}^{2} + {f}^{2} )}^{1 / 2} , k = 2 π / λ ( where λ is the imaging wavelength ) .$$

Here, r is the physical spatial variable of the wavefront phase-modulation (phase-profile distribution) function of the illumination angle-encoded mapping metasurface optical element (generalized for X/Y or radial dimensions). The physical center of the metasurface optical element is positioned at the origin (r=0), and the surface normal corresponds to the reference principal optical axis of the illumination component. In some embodiments, the configuration may be coaxial or co-axial with symmetric distribution.

In some embodiments, r may be configured within a range from several hundred micrometers to 1 mm to minimize the component volume.

In general, r may vary spatially across the metasurface according to either a symmetric or an asymmetric distribution.

The parameter f is defined as the distance between the planar physical center of the illumination angle-encoded mapping metasurface optical element and the center of the illumination source. In some embodiments, the surface normal of the illumination source may be configured coaxial or co-axial with the principal optical axis of the illumination component in symmetric distribution. In some embodiments, f may be configured within a range from tens of micrometers to 1 mm to minimize the component volume.

In other embodiments, the parameter f may be configured within a range from 0 to 1 mm.

A cavity may be filled with a high refractive index optical medium to couple the light extraction efficiency (LEE), which also benefits the mechanical structural encapsulation protection and operational stability of the LED chip/die and wire bonds. Correspondingly, this configuration enables a narrowed FOIi for the illumination source radiation model.

Furthermore, compared to conventional LED chips/dies measuring several tens of micrometers, silicon-based micro LED typically features a compact and efficiently utilized optical emission area. The silicon-based micro LED compatible with CMOS processes, making them more amenable to on-chip packaging as Photonic Integrated Circuits (PICs).

In some embodiments, constraints imposed by the proportion between the physical size of the LED/microLED chip/die and the spatial distance f, phase engineering optimization may be applied to adapt to varying conditions.

In some embodiments, the numerical integration of the phase gradient Φ′(r) may be performed using physics-mathematics numerical-simulation software such as COMSOL, MATLAB, or Mathematica to obtain the corresponding phase profile distribution Φ(r), with optional nonlinear fitting for equivalence. Subsequently, optical-simulation software such as Zemax or CODE V may be applied to simulate and globally evaluate the far field projection intensity distribution of LED or VCSEL illumination source, followed by adaptive parameter optimization.

In some embodiments, rigorous coupled-wave analysis (RCWA) and optimization tools based on scalar diffraction theory may be applied to achieve higher accuracy.

Based on the relationship between the aperture of the illumination angle-encoded mapping metasurface optical element and the spatial position of the R_{eyebox}, the angle-encoded mapping generates actual asymmetric exit field of illumination [θₙ, θ_{f}] at the aperture edge that is approximately (slightly less than) FOIᵣ, while the projected region on the eye object-plane matches the intended R_{eyebox} exactly:

$$[ {θ}_{n} , {θ}_{f} ] = [ arctan ( ( {R}_{eyebox} * cos {θ}_{r} - f * tan {θ}_{in} ) / ( {R}_{relief} / cos {θ}_{r} + {R}_{eyebox} * sin {θ}_{r} ) ) ,$$

$$arctan ( ( {R}_{eyebox} * cos {θ}_{r} - f * tan {θ}_{if} ) / ( {R}_{relief} / cos {θ}_{r} + {R}_{eyebox} * sin {θ}_{r} ) ) ]$$

As a variant under the identical principle, in other embodiments a VCSEL illumination-source radiation model may be configured. Following projection by means of the illumination angle-encoded mapping onto the object plane, a homogenized far field irradiance profile on R_{eyebox} is generated. The illumination source radiation model is configured as a Gaussian radiator profile distribution relative to a surface normal radiant intensity, which differs from the LED illumination source embodiment:

$$Ω ( φ i ) = 2 π * Io * \int exp [ - 2 * {( θ / σ )}^{2} ] sin θdθ θ = [ 0 , φ i ]$$

$$φ i = arctan ( r / f )$$

where σ is the Gaussian bandwidth of the VCSEL illumination source radiation model. It typically refers to the 1/e² half-angle of the normal radiation intensity, Io.

In some instances, the configuration of r may be selected within the range of several tens micrometers to 1 mm, which facilitates the reduction of spatial volume.

In some instances, the configuration of f may be selected within the range of several hundred micrometers to 1 mm. Based on the VCSEL illumination source radiation model, due to its vertical light emission characteristics and internally integrated optical resonant cavity structure, the optical performance of VCSEL is nearly optimal at the chip level. It features a relatively narrower FOIi and minimal beam aperture, high light extraction efficiency with strong coupling, may not require high refractive index optical media filling, and may be integrated into on-chip photonic integrated circuit (PIC) packaging.

In some embodiments, the illumination component is configured to generate a homogenized and/or a structured pattern projected on the object plane.

A generalized framework based on the spherical wave source model or the plane wave source model is constructed as following.

The illumination source radiation model may be expressed in a generalized unified form with angular dependence:

$$Ω ( φ i ) = 2 π * {I}_{o} * \int P ( θ ) sin θdθ θ = [ 0 , φ i ]$$

$$φ i = arctan ( r / f )$$

where P(θ) is the profile distribution function characterizing the variation of the illumination source radiant intensity with the incidence angle θ relative to the surface normal.

Furthermore, under a multi-illumination source radiation model, P(θ) may be derived from a statistical nonlinear fitting of the aggregate far-field illumination profile distribution.

The optical characteristic relationship of the far field illumination irradiance profile distribution with the homogenized or structured pattern is configured with a corresponding target irradiance function between the projected optical radiant power and the projected area on the object plane of the eye.

The far field illumination irradiance profile distribution is configured with the homogenized or structured pattern, wherein the optical characteristic relationship is characterized by a target irradiance function correlating the projected optical radiant power to the projected area on the object plane of the eye.

Equation 2 with composite function R(r) may be expressed in a generalized unified form based on the spherical wave source model or the plane wave source model:

$$d Ω ( r ) * cos θ r = Ei ( r ) * dSi ( r ) = Et ( R ) * dSt ( R )$$

where, Ei(r) is the irradiance function on the illumination angle-encoded mapping metasurface optical element, generated by the illumination source radiation model. dSi(r) is the differential area element associated with the variable r on the illumination angle-encoded mapping metasurface optical element. Et(R) is a constant target irradiance function for a desired far field irradiance profile distribution with homogenized pattern on the object plane.
or,
Et(R) is a corresponding target irradiance function for a desired far field irradiance profile distribution with structured pattern on the object plane. dSt(R) is the differential area element associated with the variable R on the object plane.

More generally, irradiance may be redefined equivalently within the framework of the formalism for radiant intensity.

Finally, based on solving an inverse problem for composite function R(r) and the generalized Fresnel formula (e.g., Eq. 4), the phase modulation function gradient (phase gradient) of a specific illumination angle-encoded mapping metasurface optical element may be derived.

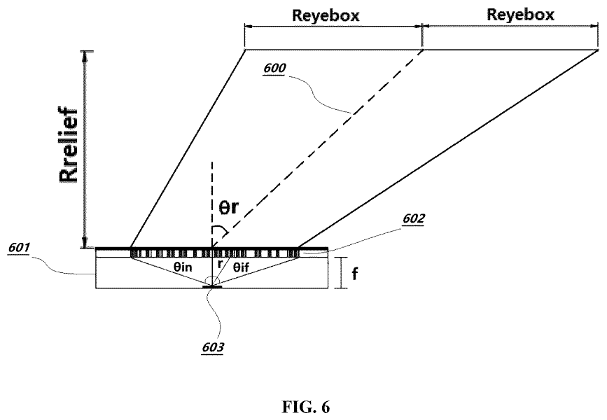

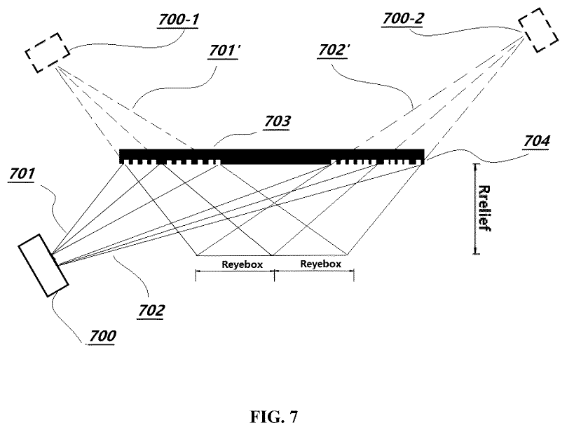

Depending on the physical mounting layout and projection mode of the illumination component, a variant embodiment may be configured as shown in FIG. 6. In the figure, the principal optical axis of the illumination component is labeled as 600, the illumination component is 601, the illumination angle-encoded mapping metasurface optical element is 602, and the illumination source is 603. In contrast to FIG. 5, where the surface normal of the illumination angle-encoded mapping metasurface optical element is coaxial or co-axial with the principal optical axis of the illumination component, in FIG. 6 the surface normal of the illumination angle-encoded mapping metasurface optical element 602 forms an angle θᵣ with the principal optical axis 600. By means of the illumination angle-encoded mapping, the principal optical axis of the illumination component is adapted to align with the angle θr.

As shown in FIG. 6, the exit field of illumination of the illumination angle-encoded mapping metasurface optical element, asymmetrically distributed relative to the principal optical axis 600, is characterized as:

$$θ n = θ on , θ f = θ of$$

When the incident angle φi is coupled into the symmetrically distributed boundary angles θin and θif, it is encoded and mapped to the exit angle φo, which corresponds to the asymmetrically distributed boundary angles θon and θof.

Accordingly, the exit field of illumination of the illumination component is FOIᵣ=[θₒₙ, θ_{of}].

For an embodiment configured with the LED illumination source radiation model, and based on the identical principle described above, the illumination angle-encoded mapping metasurface optical element manipulates incident angle of the beam from the illumination source and maps them to corresponding exit angle of the beam projected onto R_{eyebox} of the eye object-plane area, thereby generating a homogenized far field irradiance profile. A specific configuration of the phase modulation function gradient (phase gradient) is characterized as:

$${Φ}^{′} ( r ) = k * \{ [ {R}_{relief} * tan {θ}_{r} + R ( r ) - r ] {/ [ {( {R}_{relief} * tan {θ}_{r} + R ( r ) - r )}^{2} + {R}_{relief}^{2} ]}^{1 / 2} - sin ( arctan ( r / f ) ) \}$$

$$where R ( r ) = {R}_{eyebox} / sin {θ}_{in} * sin ( arctan ( r / f ) ) , or R ( r ) = {R}_{eyebox} / sin {θ}_{if} * sin ( arctan ( r / f ) ) .$$

$$Equivalently :$$

$${Φ}^{′} ( r ) = k * \{ [ {R}_{relief} * tan {θ}_{r} + R ( r ) - r ] {/ [ {( {R}_{relief} * tan {θ}_{r} + R ( r ) - r )}^{2} + {R}_{relief}^{2} ]}^{1 / 2} - f ( r ) \}$$

$$where R ( r ) = {R}_{eyebox} / sin {θ}_{in} * f ( r ) , or R ( r ) = {R}_{eyebox} / sin {θ}_{if} * f ( r ) ;$$

$$f ( r ) = r / {( {r}^{2} + {f}^{2} )}^{1 / 2} .$$

The illumination source may be different types of models, such as spherical or plane wave source model. After projection by means of the illumination angle-encoded mapping metasurface optical element onto the object plane, a homogenized far field irradiance profile distribution is generated on the R_{eyebox} area of the object plane of the eye.

The exit aperture of the illumination component is configured as NAᵣ=2f*tan(θ_{if}), corresponding to the symmetric incident field of illumination of the illumination source. For AR/AI glasses, the total package volume of the illumination component may be strictly limited to about 0.008 cc. In some embodiments, the overall thickness is limited to about 2 mm, with f less than 200 μm, 100 μm, or below, and r less than 1 mm.

For near-eye display (NED) scenarios, eyerelief and ocular biosafety constraints require that the irradiance Et projected by the LED or VCSEL illumination source onto the eye surface is maintained well below 10 mW/cm². Combined with low-power and thermal-management requirements, this means that, in some embodiments, the LED or VCSEL illumination source does not require configuration as an array form to achieve high radiant intensity projection onto the eye surface.

In some instances, the physical area of LED/microLED chip/die may be configured within the range of tens to 100 micrometers (e.g., 50 μm), while the physical aperture of a single-mode VCSEL may be configured to approximately 10 μm.

The illumination source operates in a low-duty-cycle, synchronous, pulse-driven illumination/exposure mode while maintaining a total optical radiant power approximated by Et*Reyebox\hat{ }2 (e.g., 1-3 mW, sub-mW) during synchronized illumination-imaging period T.

The illumination angle-encoded mapping metasurface optical element may is configured with subwavelength structures that modulate transmitted light by means of propagation phase, including but not limited to meta-atoms such as nanocubes, nanopillars and other nanopillars with optically isotropic cross-sections. In some embodiments, nanopillar meta-atoms feature polarization insensitivity and relatively simple, manufacturable geometries. The unit-cell structure parameters of such meta-atoms include diameter, period, and height. At a position r, the meta-atom diameter may be determined from the desired transmittance and the phase delay specified by the wavefront phase-modulation function Φ(r) (phase profile distribution).

The illumination angle-encoded mapping metasurface optical element is also configured with different dielectric materials substrate and/or subwavelength nanostructure constructions, thereby tuning sensitivity to incident angle of the beam, wavelength, and polarization. For example, in some embodiments, subwavelength rectangular block structures with anisotropic cross-sections, such as nanobricks/nanoblocks, are configured.

By tuning their length, width, and height, orientation angle (anisotropy), phase responses in two orthogonal polarization directions are independently manipulated. These are core unit cells for polarization-dependent metasurfaces.

As will be understood by one of ordinary skill in the art from the present disclosure, one or more illumination sources may include: light-emitting diode (LED), micro-LED (mLED), edge-emitting LED, organic LED (OLED), inorganic LED (ILED), active-matrix OLED (AMOLED), transparent OLED (TLED), superluminescent LED (SLED), another suitable LED, vertical-cavity surface-emitting laser (VCSEL) or another type of laser, a photonic-integrated-circuit-based (PIC) illuminator, liquid-crystal display (LCD), an illumination source with a MEMS-based scanner, any other suitableillumination source, and/or any combination thereof.

The foregoing illumination-source examples are provided only for principle explanation and are not intended to be exclusive or limiting. Equivalent generalized variants may exist and be implemented.

### Imaging/Illumination Component Extensions

The foregoing illumination and imaging angle-encoded mapping metasurface optical elements are transmissive metasurface optical elements. As an extended, variant, or equivalent embodiment for substantive application, reflective illumination/imaging metasurface optical elements may be adapted to a light waveguide or lens to create predetermined multi-field of view and predetermined multi-field of illumination.

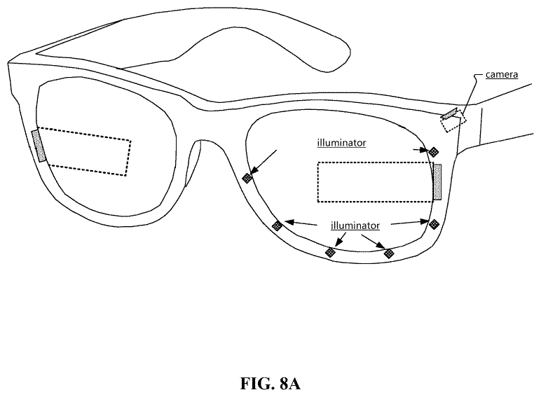

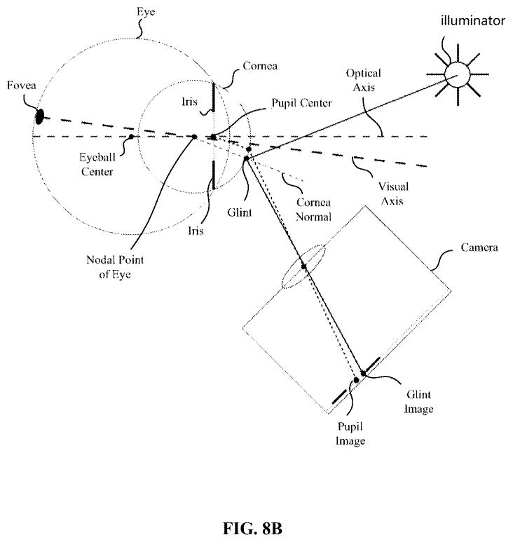

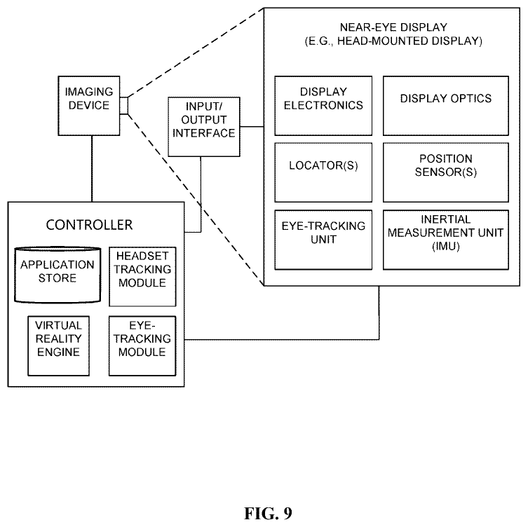

In some embodiments, the imaging/illumination component is configured as shown in FIG. 7. In the figure, the imaging/illumination component is 700. A virtual component on one side is 700-1, and a virtual component on the opposite side is 700-2. The field of view or field of illumination on one side is 701, with its corresponding virtual angle 701′. The opposite-side angle is 702, with its corresponding virtual angle 702′. A reflective illumination/imaging metasurface is located on one side of a light waveguide or lens as 703, and on the opposite side as 704. In this embodiment, 700-1/700-2 and 701′/702′ are virtual representations corresponding to 700 and 701/702, respectively, for intuitive understanding of the optical principle. This is equivalent to simultaneously arranging imaging/illumination components on both sides in combination.

Based on at least one of predetermined positioning location on the light waveguide or lens, the corresponding reflective illumination/imaging metasurface optical element 703 or 704 is configured as reflective-angle combiner, transmitting the incident beam from the object plane of the eye to the imaging component and/or transmitting the exit beam from the illumination component to the object-plane region.

In some embodiments, the reflective illumination/imaging metasurface optical element 704 may be positioned by imprinting, etching, or inlaying within the out-coupling region 703 of a waveguide optical projection display system for stacked multiplexing. In other embodiments, the reflective illumination/imaging metasurface optical element 704 may be positioned outside the out-coupling region to simplify fabrication complexity and avoid possible impact on display performance. In further embodiments, the reflective illumination/imaging metasurface optical element 704 may be positioned on the lens surface 703 by imprinting, etching, inlaying, injection, or cold-casting processes. In some embodiments, an off-axis reflective holographic optical element (rHOE) may be configured. In other embodiments, a reflective coating film may be configured.

In some embodiments, predetermined multiple field of view and/or multiple field of illumination are arranged on opposite sides in combination, such as positions 701 on one side of R_{eyebox} of the eye object-plane region and 702 on the opposite side in FIG. 7.

The incident field of view of the imaging component may be expanded by optical stitching or merging, with overlapping or non-overlapping configurations to create multi-view 3D imaging. As shown in FIG. 7, imaging component 700 generates a one-side field of view 701 and an opposite-side field of view 702.

The field of view of the imaging component is expanded by means of optical stitching or merging based on the viewpoints/viewing angles at the predetermined distinct positioning locations.

By the identical principle, the exit field of illumination of the illumination component may be expanded by optical stitching or merging, with non-overlapping configurations to create multi-angle illumination. As shown in FIG. 7, illumination component 700 generates a one-side field of illumination 701 and an opposite-side field of illumination 702. The field of illumination of the illumination component is expanded by means of optical stitching or merging based on the viewpoints/viewing angles at the predetermined distinct positioning locations,

In some examples, reflective illumination/imaging metasurface optical elements 703/704 of the imaging component may be configured with predetermined imaging angle-encoded mappings, thereby eliminating the need for an imaging angle-encoded mapping metasurface optical element inside the imaging component.

Although the embodiments above illustrate positioning at one side and the opposite side of the eye object-plane region, the positioning locations are not limited to specific positions or quantities.

The embodiments ensure that during eye rotation tracking, when the gaze direction deviates toward either side, the corresponding eye rotation to that side may be selectively positioned at an optimal field of view/field of illumination This characteristic is critical for practical eye tracking applications, since the ability to locate a suitable field of view/field of illumination directly affects tracking accuracy and precision.

As an extended, variant, or equivalent embodiment of the substantive principle, and different from the above reflective illumination/imaging metasurface optical elements, predetermined multiple field of view and predetermined multiple field of illumination may be created by adapting in-coupling/out-coupling metasurface optical elements (in-coupler/out-coupler) to a light waveguide.

Based on at least one of predetermined positioning location on the light waveguide, an in-coupling metasurface optical element transmits incident beams from the eye object-plane region into the light waveguide, which propagate by total internal reflection (TIR), and an associated out-coupling metasurface optical element couples them out into the imaging component. Likewise, an in-coupling metasurface optical element may transmit exit beams from the illumination component into the waveguide, which propagate by TIR, and an associated out-coupling metasurface optical element couples them out into the eye object-plane region.

In some embodiments, the light waveguide is configured with a high-refractive-index n, and the TIR angle (arcsin(1/n)) meets the conditions of the predetermined field of view and/or the predetermined field of illumination.

In some embodiments, the in-/out-coupling metasurface optical elements may be located in the out-coupling region of a waveguide optical projection display system for stacked multiplexing by imprinting, etching, or inlaying. In other embodiments, they may be positioned outside the out-coupling region to simplify fabrication complexity and reduce possible impact on display performance. In some embodiments, other equivalent optical elements may be configured, such as a micro-reflector array (MRA), a surface-relief grating (SRG), or a polarization-volume hologram grating (PVH).

In some embodiments, the predetermined multiple field of view and/or predetermined multiple field of illumination are arranged in combination on opposite sides, such as one side and the opposite side of R_{eyebox} of the eye object-plane region.

The imaging component's incident field of view may be expanded by optical stitching or merging, with overlapping or non-overlapping configurations to create multi-view 3D imaging. That is, the imaging component generates a one-side field of view and an opposite-side field of view, and by viewpoint/viewing angle at predetermined distinct positioning locations, the field of view is expanded by optical stitching or merging.

By the identical principle, the field of illumination of the illumination component may be expanded by optical stitching or merging, with non-overlapping configurations to create multi-field of illumination illumination. That is, the illumination component generates a one-side field of illumination and an opposite-side field of illumination, and the field of illumination of the illumination component is expanded by means of optical stitching or merging based on the viewpoints/viewing angles at the predetermined distinct positioning locations.

In other embodiments, when the imaging and illumination components are positioned for stacked multiplexing in the out-coupling region of a waveguide optical projection display system, the optical propagation path points directly to the eye object-plane region (eyebox), forming coaxial (on-axis) illumination and imaging. In this special degenerate case, the principal optical axis angle θᵢ of the imaging component and the principal optical axis angle θr of the illumination component both reduce to 0. All FOVᵢ/FOVᵣ/FOIᵣ/FOIᵢ are symmetric. The imaging angle-encoded mapping metasurface optical element inside the imaging component may thus be omitted for direct imaging. In some examples, the imaging component may be configured to operate in object-space telecentric or bi-telecentric mode. The predetermined exit pupil or aperture stop of the imaging component is located at the image-space focal plane.

The illumination angle-encoded mapping metasurface optical element of the illumination component is configured for coaxial uniform illumination with θᵣ=0. As described above, in some examples, the illumination component may be configured to operate jointly with an optical combiner such as a collimator. Under volume constraints, the collimator may be configured as a metasurface collimator. A specific metasurface collimator optical element is characterized by a phase-modulation function gradient (phase gradient):

$${Φ}^{′} ( {r}_{c} ) = - k * [ ( {r}_{c} - r ) / {( {( {r}_{c} - r )}^{2} + {R}_{c}^{2} )}^{1 / 2} ]$$

where r_{c} is the physical spatial variable (generalized X/Y or radial) of the wavefront phase-modulation function (phase profile distribution) of the metasurface collimator optical element. The physical center of the element is positioned at the origin (r_{c}=0), and its surface normal is aligned with the principal optical axis of the illumination component. In some embodiments, the element may be configured as coaxial or co-axial with symmetric distribution, and with a predetermined exit-aperture size Raperture (X/Y or radial).

R_{c} is the distance between the planar physical center of the metasurface collimator optical element and the center of the illumination component.

In some embodiments, the illumination component is configured to operate jointly with the collimator so that R_{relief}=R_{c}, R_{eyebox}=Rₐₚₑᵣₜᵤᵣₑ, and θᵣ=0. In some examples, R_{c} (air gap or optical medium) may be selected in the range of several hundred micrometers to 1 mm to facilitate compressing the space volume, and Raperture may be selected in the range of several hundred micrometers to 2 mm.

The illumination component generates a collimated or parallel exit beam with a predetermined exit aperture (Raperture) via the collimator. In some examples, a light waveguide with corresponding in-coupler and out-coupler along the propagation direction may be configured and multiplexed for combined imaging and illumination.

For the illumination optical path combined with the light waveguide, the collimated or parallel exit beam from the illumination component is coupled into the waveguide via an in-coupling optical element, propagates by total internal reflection (TIR), and is coupled out by an associated out-coupling metasurface optical element into the eye object-plane region R_{eyebox}. Typically, R_{eyebox}>10 mm, and 1D/2D exit pupil expansion (EPE) may be implemented in the waveguide.

Furthermore, the total optical efficiency of an AR waveguide system involves loss throughout the entire optical chain. A simplified expression of the total efficiency is:

$$Total efficiency = in - coupling efficiency * waveguide transmission \\ \\ efficiency * EPE efficiency * out - coupling efficiency .$$

In some examples, a high-performance metasurface grating may be configured with a subwavelength nanopillar array. Parameters such as grating period, height, and nanopillar width and pitch (e.g., cylindrical nanopillar) may be optimized using a machine-learning algorithm for multi-objective tradeoff, achieving an optimal balance between average diffraction efficiency and angular uniformity. The optimization is simultaneously performed for both transverse-electric (TE) and transverse-magnetic (TM) incident polarization states.

Conversely, in the inverse-multiplexed imaging optical path with the light waveguide, a collimated or parallel incident beam from the eye object-plane region is coupled into the waveguide via an in-coupling optical element, propagates by TIR, and is coupled out by an associated out-coupling optical element into the imaging component.

An object point on the object plane of the eye may be encoded and mapped to a corresponding image point in the imaging component, featuring an optical conjugate property.

The foregoing examples are provided only for principle explanation and are not intended to be exclusive or limiting. Equivalent generalized variants may exist and be implemented, such as different predetermined positioning locations and quantities of field of view and/or field of illumination.

Next, several variant embodiments based on polarized illumination/imaging component is introduced for 3D eye movement/gaze direction, biometrics or dynamic qualitative/quantitative monitoring and analysis of physiological states, maintaining consistency with the descriptions in other embodiments.

In some embodiments, the eye tracking system of a head-mounted device comprises: the illumination component configured to project at least one polarization state onto the eye, the imaging component configured to capture an image using the image sensor that is sensitive to at least one corresponding polarization state; and the controller configured to generate at least one combination of parallel and orthogonal polarization states, synchronize timing and process a polarization intensity data from the image.

The polarization intensity data is configured with at least one of
1. a cross-reference feature defined as the pattern modality of corneal polarization interference intensity, and
2. a dynamic-reference feature defined as the dynamic relational characteristic generated from eyeball motion.

The cross-reference feature or dynamic-reference feature is configured to characterize at least one of a 3D eye movement, and an ocular physiological state.

In some embodiments, the controller is configured with a lightweight deep learning model to perform end-to-end predictive inference for outputting at least one of the 3D eye movement, and the ocular physiological state.

In some embodiments, the controller is configured with at least one of a manually engineered feature extraction, and an autonomous high-dimensional feature extraction via a dual- or multi-channel feature fusion module in the deep learning model.

In some embodiments, the polarized illumination/imaging component is configured with linear/chiral circular-polarization-sensitive optical metamaterials/structures, (e.g., helical chiral circular-polarization-sensitive structures/metamaterials) or metasurface polarization gratings, featuring: the circular polarization metasurfaces with circular dichroism (CD)>80%, 90% or higher and transmittance >50%, 60%, 70%, 80%, 90%, or higher at a wavelength of 940 nm, the linear polarization metasurfaces with extinction ratio >100:1, 1000:1, or higher; transmittance >50%, 60%, 70%, 80%, 90%, or higher at a wavelength of 940 nm.

In some embodiments, high performance all-dielectric pixelated full-Stokes polarization metasurfaces in the near-infrared band based on silicon, which is compatible with the available CMOS semiconductor industry technologies. Circular polarization (CP) metasurfaces with high circular dichroism (CD) are achieved by using simple two-dimensional chiral structures, which may be easily integrated with the linear polarization metasurfaces on a system of chip. In addition, the dielectric materials have higher transmission than metal materials with intrinsic absorption.

In some embodiments, for pixelated full-Stokes polarization metasurfaces, each pixel has four spatially distributed polarization structures, linear polarization (LP) structures are configured with nanowire gratings oriented in three different directions to transmit linearly polarized light, whose directions of electric field vectors are oriented at 0°, 90°, 45° with respect to the x axis, respectively. The LP structures transmit the TM polarized light with the electric field direction perpendicular to the grating grooves, while blocking the transmission of TE polarized light with the electric field direction parallel to the grating grooves. The CP structures are configured with the special parity symmetry shaped planar patterns, transmit right-handed circularly polarized (RCP) light and blocks left-handed circularly polarized (LCP) light, or vice versa.

In other embodiments, the pixelated polarization metasurfaces of the polarized illumination/imaging component may be stabilized via metasurface structures fabricated by etching, with subwavelength periods and etching depths. Such subwavelength metasurface structures may be mass-produced at high throughput and low cost using nanoimprint lithography.

In other embodiments, the polarizing dielectric materials may include aluminum (Al), titanium dioxide (TiO₂), aluminum oxide (Al₂O₃), tungsten (W), silicon dioxide (SiO₂), silicon (Si), silicon nitride (Si₃N₄), and amorphous silicon (a-Si) etc.

In some embodiments, a phase retarder is stacked on the metasurface grating linear polarizer (LP) layer, where the retarder comprises nanopillars (metal/dielectric meta-atoms) with a predetermined phase retardation along orthogonal directions. The fast/slow axes of the retarder are configured at +45°/−45° relative to the transmission axis of the metasurface grating to generate right-handed/left-handed circular polarization (RCP/LCP).

In some embodiments, a multi-polarization-state metasurface grating or linear/chiral circular-polarization-sensitive optical metamaterial may be stacked atop an image sensor layer.

In some embodiments, the polarized illumination/imaging component may be configured using tunable liquid crystal (LC)/phase-change materials to achieve real-time, independently controllable polarization state switching. This tunability enhances polarization-state resolution.

The polarized illumination/imaging system (particularly RCP/LCP configurations) provides:
(a) Environmental stray light suppression-blocking complex ambient light including
   Direct incident light (AOI)
   Primary/secondary indirect reflections
(b) Ocular surface reflection mitigation-reducing interference from:
   Eye surface contaminants (tears, secretions)
   Periocular skin reflections (cosmetics, oils)

This enables the acquisition of high-quality polarization-state intensity images in eye image sequences.

Since natural environments exhibit negligible circular polarization (CP), compared to linear/partially linear polarization (LP), in most scenarios, some embodiments may adopt RCP/LCP configurations to:
Effectively eliminate ambient stray light in imaging
Enhance optical signal-to-noise ratio (SNRo) with improvements exceeding 20 dB in clinical tests.

### Example 1

The controller configures the polarized imaging component to form a 2×2 pixelated multi-polarization-state imaging array with 0°+90°+45°+135° orientations. Correspondingly, the polarized illumination component is configured to operate in any one of 0°/90°, 45°/135°, or any combination thereof.

### Example 2

The controller configures the polarized imaging component to form a 2×2 pixelated full-polarization-state imaging array with 0°+90°+45°/135°+RCP/LCP orientations. Correspondingly, the polarized illumination component is configured to operate in any one of 0°/90°, 45°/135°, RCP/LCP, or any combination thereof.

### Example 3

The controller configures the polarized illumination component to form a 2×2 switchable multi-polarization-state illumination array with 0°+90°+45°+135° orientations. Correspondingly, the polarized imaging component is configured for pixelated polarization imaging in any one of 0°/90° or 45°/135° polarization state.

### Example 4

The controller configures the polarized illumination component to form a 2×2 switchable full-polarization-state illumination array with 0°+90°+45°/135°+RCP/LCP orientations. Correspondingly, the polarized imaging component is configured for pixelated polarization imaging in any one of 0°/90°, 45°/135°, or RCP/LCP polarization state.

In some embodiments, the controller is configured to:
(i) synchronize the timing of:
optical radiation from the polarized illumination component, and
the exposure (integration) periods of the polarized imaging component.
(ii) establish addressable encoding associations for each parallel (identical) and orthogonal polarization-state combination during illumination-imaging operations; and
(iii) selectively activate/deactivate specific polarization states through asynchronous switching.

The controller receives digitized polarization-intensity data (pixelated image) from the image sensor, generated from at least one configured combination of parallel (identical) and orthogonal polarization states.

In some embodiments, the polarization-intensity data (pixelated images) generated by parallel (identical, denoted as p) and orthogonal (denoted as s) polarization-state combination configurations for illumination and imaging are specifically defined as follows:

### 1. Independent Polarization State Set:

{0°, 90°, 45°, 135°, RCP, LCP}

### 2. Orthogonal Polarization-State Combination Set s:

{(0°,90°), (45°,135°), (RCP,LCP)}

### 3. Parallel (Identical) Polarization-State Combination Set p:

{(0°,0°), (45°,45°), (RCP,RCP)}
or equivalently:
{(90°,90°), (135°,135°), (LCP,LCP)}
   4. Parallel+Orthogonal Combination Set p+s:
{(0°,0°)+(0°,90°), (45°,45°)+(45°,135°), (RCP,RCP)+(RCP,LCP)};
or equivalently:
{(90°,90°)+(0°,90°), (135°,135°)+(45°,135°), (LCP,LCP)+(RCP,LCP)};

The polarization-intensity data (pixelated image) corresponding to: the parallel (identical) polarization-state combination set p is denoted as Ip; the orthogonal polarization-state combination set s is denoted as Is.

In different embodiments, any subset of the above combination sets may be implemented.

The above configurations of parallel (identical) and orthogonal polarization-state combinations are presented for illustrative explanation of operational principles only, and are not intended to be exclusively limiting. Equivalent variants based on the same underlying principles may be realized and implemented.

The birefringence of the ocular cornea is a core aspect of its optical properties, arising from the highly ordered arrangement of collagen fibrils and the unique characteristics of the surrounding biological matrix.

The lamellar structure of corneal collagen fibrils is the primary source of optical anisotropy and birefringence. Their radially symmetric, circumferential alignment directly contributes to the observed biological birefringent effects.

The optical mechanisms underlying corneal birefringence include:
(i) Angular rotation and phase retardation of incident light due to the curvature of the corneal surface.
(ii) Phase retardation caused by the circumferential angular orientation of birefringent collagen fibrils within the cornea.

The cornea behaves as a uniaxial birefringent medium, exhibiting refractive index differences along orthogonal polarization axes.

Light incident parallel or perpendicular to the corneal surface remains unaffected, while obliquely incident light undergoes polarization axis rotation and phase retardation. This is effectively equivalent to altering the angular relationship between the polarization direction and the fast/slow axes of the cornea.

In some embodiments, when the transmission axes of the polarized illumination component and imaging component are configured as either parallel (identical) or orthogonal, the birefringence of the corneal biotissue (determined by optical parameters such as birefringence index |n₀−nₑ|, wavelength, and corneal thickness) induces a polarization interference effect.

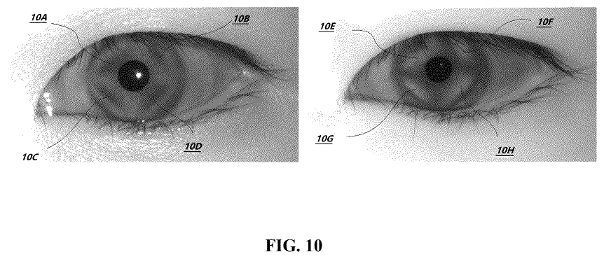

This effect is characterized by the interference intensity between parallel (identical) and orthogonal polarization state, exhibiting approximately symmetric periodicity and manifesting as four phase-inverted maxima and minima. These properties are reflected in the characteristics of the imaging pattern modality, as illustrated in FIG. 10.

The parallel (identical) and orthogonal polarization state combination, configured as p+s, is: (0, 0)+(0, 90).

Relative to the parallel (identical) polarization-state combination subset p=(0,0) in the illumination/imaging configuration, within the imaging pattern modality, the regions 10A/10B/10C/10D show destructive interference, while the remaining regions show constructive interference.

Relative to the orthogonal polarization-state combination subset s=(0,90) in the illumination/imaging configuration, within the imaging pattern modality, the regions 10E/10F/10G/10H show constructive interference, while the remaining regions show destructive interference.

The pattern modality of corneal polarization interference intensity between parallel (identical) and orthogonal polarization state exhibiting polarity inversion may be characterized by a cross-reference feature and may serve as a corneal characteristic of the eye.

In some other embodiments, the cross-reference feature may serve as an enhanced composite factor for a first 3D eye movement/gaze direction characteristics.

In some other embodiments, the cross-reference feature may serve as biometrics of individuals.

In some other embodiments, the cross-reference feature may serve as long-term health monitoring of individuals, dynamic qualitative/quantitative analysis of ocular physiological state.

Despite non-uniform corneal thickness variations and inter-individual biological differences, the cross-reference feature of the corneal polarization interference intensity pattern corresponding to birefringence effects remains consistent within the same individual.

In some embodiments, individual recalibration may be performed under standardized conditions, such as visual axis/optical axis/fixation direction consistency.

Multiple combined illumination-imaging configurations employing parallel (identical) and orthogonal polarization states generate corresponding imaging pattern modality reflecting: corneal polarization interference intensity variations, thereby providing cross-reference feature with enhanced accuracy and stability. In various embodiments, the aforementioned cross-reference feature data may be implemented in any subset of the combined configuration set.

From an information-theoretic perspective, the cross-referenced feature encoding of polarity inversion channels (identical and orthogonal polarization state) is capable of maximum entropy, simultaneous noise suppression (optical noise, electrical noise etc.) interference cancellation (motion artifacts, random polarized light etc.) and signal enhancement of the pattern modality (corneal polarization interference intensity).

The controller, pre-trained via a lightweight machine/deep learning model (e.g., CNN, DNN, RNN, GNN, ViT) using a high-dimensional mapped cross-reference feature dataset of at least one or multiple polarization state combination configurations, including corneal polarization interference intensity pattern, is configured to perform end-to-end inference for predicting 3D eye movement/gaze direction, biometrics or dynamic qualitative/quantitative monitoring and analysis of ocular physiological state.

Machine/deep learning models may learn intrinsic pattern modality of high-dimensional mappings that characterize eye physiological state through pre-training on cross-reference feature dataset of corneal polarization interference intensity pattern.

In some embodiments, data preparation generates a high-dimensional mapped dataset comprising cross-reference features derived from at least one or more combination configurations of parallel (identical) and orthogonal polarization states, along with their corresponding physiological states. The controller, after being pre-trained by inputting this high-dimensional mapped dataset through lightweight machine/deep learning models, performs end-to-end predictive inference to output 3D eye movement/gaze direction, biometrics or dynamic qualitative/quantitative monitoring and analysis of ocular physiological states.

In some embodiments, the cross-reference features of corneal polarization interference intensity variation imaging pattern may be defined based on manually engineered feature extraction, such as differential feature (Ip−Is) or contrast features including but not limited to Is/(Ip+Is) and (Ip−Is)/(Ip+Is).

In some embodiments, the cross-reference features of corneal polarization interference intensity variation imaging pattern may incorporate a dual- or multi-channel feature fusion module within the deep learning model, where Ip and Is are respectively input into the feature fusion module to perform autonomous high-dimensional feature extraction.

In some instances, the implementation method based on the difference convolution feature extraction module operates directly on the feature level in an implicit and lightweight manner for differential feature extraction. The process includes:
(i) Inputs Ip and Is are processed by a CNN with shared weights to extract base features Fp and Fs respectively.

$$Calculate the feature difference : Diff = Fp - Fs$$

$$Calculate the feature sum : Sum = Fp + Fs$$

(ii) Channel-wise Concatenation: Concatenate Diff and Sum along the channel dimension to obtain X=concat(Diff, Sum).
(iii) Convolutional Fusion: Use a convolutional layer Conv(X) to fuse the differential information and output the final differential features.

The difference convolution feature extraction module may be configured as a sub-module inserted into mainstream architectures (e.g., CNNs, Transformers).

In some embodiments, following the same principle described above, self-supervised or unsupervised learning is implemented using an image pair. An cross-reference pair, consisting of the parallel polarization interference image (Ip) and the orthogonal polarization interference image (Is), serves as the built-in supervision to disentangle the feature information.

The cross-reference pair form complete feature representations.

In some implementations, the model may be an explicit regularization model based on feature-difference, or an implicit prior regularization model.

The transformer model excels at modeling long-range dependencies, while feature fusion incorporates local details and multi-level visual information. The effective combination of both endows the model with global comprehension and local perception capabilities, significantly enhancing performance and generalizability while reducing computational costs.

The transformer learns feature dependencies within image channels through channel-wise self-attention mechanisms, while incorporating a multi-scale feature extraction and fusion module to effectively process global information with improved computational efficiency.

In some embodiments, the deep learning model is configured to incorporate a dual-/multi-channel feature fusion block within a Transformer-based ViT backbone network for direct disentangling of Ip and Is cross-reference feature. The feature fusion block enhances multi-scale spatial feature representation by disentangling Ip and Is cross-reference feature through dual/multi-channel processing, followed by global integration with original features. Utilizing cross-attention mechanisms for spatial relationship modeling of cross-reference features, the block performs spatial and cross-channel information disentangling via convolutional feedforward networks.

In some embodiments, a bidirectional spatiotemporal convolutional network architecture may be configured to simultaneously extract spatiotemporal features from both forward and reverse temporal sequences, while a self-attention mechanism is employed to highlight critical features based on the extracted spatiotemporal features.

In other embodiments, a Time-Difference Mamba (TD-Mamba) block may be incorporated with a dual-stream SlowFast architecture, wherein the model efficiently processes both short-term and long-range temporal features to enhance detection accuracy of dynamic variations in cross-reference features.

The aforementioned cross-reference feature extraction configurations are provided solely as exemplary illustrations of operational principles, and shall not be construed as exclusive or limiting. Variants embodying equivalent principles may be generalized and implemented without departing from the scope of this disclosure.

Since the Ip and Is images inherently encompass periocular regions, the corneal polarization interference intensity pattern occurs specifically in the transparent corneal zone, while its corresponding characterization is observed in the anatomically posterior iris region.

In some exemplary embodiments, the region of interest (ROI) for corneal polarization interference intensity pattern may be defined as the iris region, where at least one or multiple combined polarization configuration dataset of the corneal interference pattern ROIs are utilized during deep learning model training or inference.

In some embodiments, the corneal polarization interference intensity pattern may be localized within a region of interest (ROI), exemplified by detecting keypoints in the iris ROI from Is+Ip composite images while excluding invalid obstructions (e.g., eyelashes, eyelids, blink artifacts). The deep learning model may perform occlusion mask annotation during training and/or inference to suppress interference. In further embodiments, standardized normalization of the ROI compensates for precision errors induced by pupil dilation/constriction.

In some exemplary embodiments, the comprehensive periorbital imaging complete ocular biological structures including the sclera, cornea, iris, pupil, and eyelids. The motion of the eyeball generates dynamic-reference feature comprising relative positional changes and contour morphological variations of these ocular components. Additionally, it incorporates supplementary dynamic-reference feature such as corneal glint and reflections from the aqueous humor/lens.

The dynamic-reference feature serves as a critical dynamic relational characteristic (e.g., dynamic contour keypoint detection) predicting the 3D eye movement/the gaze direction, particularly under conditions like glasses slippage or insufficient eye opening.

The deep learning model enhances prediction accuracy and stability by incorporating the aforementioned dynamic-reference feature from images as a second 3D eye movement/gaze direction enhancement combinatorial factor during training and/or inference. The dynamic-reference feature may be reinforced by the deep learning framework in spatio-temporal evolving pattern, forming logically associated memory traces.

The exemplary deep learning model configurations described above, which are driven by cross-reference feature data derived from corneal polarization interference intensity pattern exhibiting polarity inversion between parallel (identical) and orthogonal polarization states, are provided solely as illustrative embodiments of the underlying principles and shall not be construed as limiting or exclusive. Various alternative implementations embodying equivalent principles may be generalized and practiced without departing from the scope of this disclosure.

In some embodiments, biometrics or dynamic qualitative/quantitative monitoring based on corneal polarization interference intensity pattern enables longitudinal comparison of individual health status data variations.

During long-term health monitoring applications, the system initializes by establishing a historical health record archive for the individual.

When changes occur in an individual's ocular health status, such as keratoconus progression, tear film, intraocular pressure fluctuations, blood pressure variations, hemodynamic perfusion abnormalities, or changes in aqueous humor glucose optical rotation etc., these alterations may induce corresponding modifications in corneal curvature, birefringence effects, and scleral scattering characteristics. These changes are reflected in the cross-reference features of corneal polarization interference intensity pattern. By comparing with historical health record archives, trained deep learning models may perform biometrics or dynamic qualitative/quantitative monitoring analysis and generate diagnostic feedback alerts.

In some embodiment applications, the image sensor may be configured with a pixel binning/subsampling mode, in which pixels of the same polarization-state channel are combined to enhance sensitivity, reduce power consumption, or increase frame rate.

The controller may be implemented as the processor and the memory. In some examples, the controller may be implemented as hardware, software, and/or a combination of hardware and software in the HMD. In some examples, the controller may be implemented, in whole or in part, by at least one of any type of application, program, library, script, task, service, process, or any type or form of executable instructions executed on hardware such as circuitry that may include digital and/or analog elements (e.g., one or more transistors, logic gates, registers, memory devices, resistive elements, conductive elements, capacitive elements, and/or the like, as would be understood by one of ordinary skill in the art). In some examples, the processor may be implemented with a general purpose single- and/or multi-chip processor, a single- and/or multicore processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the memory may be implemented by one or more components (e.g., random access memory (RAM), read-only memory (ROM), flash or solid state memory, hard disk storage, etc.) for storing data and/or computer-executable instructions for completing and/or facilitating the processing and storage functions described herein. In such examples, the memory may be volatile and/or non-volatile memory, and may include database components, object code components, script components, or any other type of information structure suitable for implementing the various activities and storage functions described herein.

For various application scenarios of AI/AR glasses, the eye tracking function under requirements for size, cost, power consumption, heat generation, frame rate, and algorithmic processing complexity, some embodiment may utilize low-resolution photoelectric sensors such as 2*2, 4*4, 8*8, 16*16, or 32*32 arrays as equivalents to replace image sensors.

In some embodiment, the types of photoelectric sensor include, but are not limited to, NIR/SWIR wavelength range based on GaAs/InGaAS, quantum dot/photodiodes (QD/PD), and SPADs. The photoelectric sensor is configured to detecting light intensity. In some embodiments, the photoelectric sensor is configured with pixel size greater than or equal to 10 μm, 20 μm, 30 μm, 40 μm, 50 μm, 100 μm, or larger, and high performance in linearity, response speed, sensitivity, operating frequency, and SNR.

The polarized imaging/illumination component configuration details are consistent with those described in the foregoing embodiments.

In some embodiments, the imaging component and illumination component comprise:
a polarized illumination component is configured to project at least one of a polarized light onto the eye surface from at least one of a position or an incident angle;
a polarized imaging component is configured to detect at least one of a corresponding polarization intensity of reflected light resulting from at least one of a position or an incident angle.

A controller is configured to control the polarized illumination component and the imaging component to generate at least one of an identical and orthogonal polarization combination configuration from at least one of a position and/or an incident angle, synchronize timing and process a polarization intensity data.

In some embodiments, a polarized illumination component is configured to project light at a plurality of positions and/or incident angles, and is combined with a pixelated polarized imaging component at a plurality positions for illumination and imaging, thereby enhancing eye-tracking accuracy.

The polarized illumination component is configured with any one of: 0° or 90° linear polarization; 45° or 135° linear polarization; right-hand or left-hand circular polarization (RCP/LCP); or any combination thereof.

The polarized illumination component is configured with a pixelated polarization photoelectric sensor, the pixelated polarization photoelectric sensor comprises 2*2 pixel unit array, wherein the pixels are arranged in a 2*2 pattern comprising:
(i) a linear multi-polarization state combination of 0°, 90°, 45°, and 135°; or
(ii) a full polarization state combination of 0° linear, 90° linear, 45°/135° linear, and RCP/LCP.

In accordance with the configuration of the polarized illumination at different positions and/or incident angles, the light reflected from the ocular surface exhibits a varying degree of polarization (DoP), which is dependent upon the angle of incidence (AOI) on the surface.

When rotational eye movement occurs, the angle of incident light changes, resulting in corresponding alterations in the polarization intensity data of the reflected light. The variations in polarization intensity data corresponding to the reflected light are detected and imaged by a pixelated polarization photoelectric sensor.

In some embodiments, the pixelated polarization photoelectric sensor is configured to operate at a predetermined operating frequency within a range from greater than kilohertz (kHz) to megahertz (MHz). The detected polarized light intensity is quantized by an analog-to-digital converter (ADC) and subsequently processed by a controller to generate polarization intensity data.

In some embodiments, the controller is configured to generate corresponding polarized light at distinct incident angle by switching between polarized illumination configuration with a plurality of positions.

In some embodiments, at least two or more polarized illumination components and imaging components are integrated and positioned at distinct locations within the eyeglass frame to provide distinct incident angles, enabling cross-combined configuration of polarized illumination and imaging.

In some embodiments, the polarized illumination components and imaging components are integrated (e.g., manufactured through photonic integrated circuit-on-chip packaging) and symmetrically positioned relative to the eye center, including:
lower-left illumination/imaging: LD_I/LD_S,
lower-right illumination/imaging: RD_I/RD_S,
left-middle illumination/imaging: LM_I/LM_S,
right-middle illumination/imaging: RM_I/RM_S.

All components are oriented toward the EYEBOX region.

The cross-combined configuration of polarized illumination and imaging is comprises with:
lower-left polarized illumination paired with imaging at four distinct positions:

$$( LD\_I + LD\_S , LD\_I + RD\_S , LD\_I + LM\_S , LD\_I + RM\_S ) ;$$

lower-right polarized illumination paired with imaging at four distinct positions: (RD_I+LD_S, RD_I+RD_S, RD_I+LM_S, RD_I+RM_S);
left-middle polarized illumination paired with imaging at four distinct positions: (LM_I+LD_S, LM_I+RD_S, LM_I+LM_S, LM_I+RM_S);
right-middle polarized illumination paired with imaging at four distinct positions: (RM_I+LD_S, RM_I+RD_S, RM_I+LM_S, RM_I+RM_S).

In the aforementioned example, only the scenario of simultaneously activating polarized illumination at a single location with polarized imaging at four other distinct locations is demonstrated. In other implementations, combinations of multiple different illumination components may be simultaneously activated concurrently with multiple imaging components operating in parallel.

Thus, any combination of polarized illumination from spatial arrangements in conjunction with polarized imaging using any available imaging component may be readily conceived and implemented by a person skilled in the art.

In some embodiments, the illumination component comprises a controller configured to manipulate a steerable beam deflector (e.g., reflecting pre-collimated light through a predetermined aperture via metasurface optical elements based on MEMS/liquid crystal/DMD/phase-change materials) to scan optical paths with predetermined incident angles. Compared to configurations with a finite number of discrete positions, the steerable beam deflector enables high-resolution precision in scanning optical paths for incident angle tuning.

To mitigate common obstructions caused by eyelashes and eyelids, some embodiments preferentially position the polarized illumination and imaging components at lateral (left/right) or inferior (lower) locations relative to the eye. This spatial configuration provides a reliable and stable incident angle alignment for both illumination and imaging pathways.

Relative to the eye center, the polarized illumination and imaging components are disposed symmetrically in both spatial position and incident angle. This symmetrical arrangement facilitates multi-perspective polarized illumination and imaging, producing cross-combined configuration polarization states at multiple orientations. This architecture enhances the precision and stability of extracted eye movement and gaze direction metrics by effectively mitigating visual occlusion that occurs during extreme rotational eye movements.

Consistent with the descriptions in other embodiments, all polarized illumination and imaging components are configured with logically synchronized timing sequences for illumination and imaging operations.

Each polarized illumination combination with specific positions and/or incident angles is configured to be associatively addressable encoding. The controller selectively actuate or deactivate individual encoded combinations, thereby enabling dynamic switching between predetermined position and/or incident angle polarization configurations.

The controller is configured to receive digitized output from the pixelated polarized photoelectric sensor, said output comprising polarization intensity data corresponding to illumination generated by at least one of a predetermined combination of illumination component position and/or incident angle.

As maintained in other embodiments, the reference features of polarization intensity data generated by at least one of a position and/or incident angle combination configuration are high-dimensionally mapped, enabling training and inference prediction based on data-driven deep learning models.

The controller via a lightweight machine/deep learning model pre-trained on a dataset of high-dimensionally mapped reference features derived from polarization intensity patterns generated by at least one of a position and/or incident angle combination configuration, is configured to perform end-to-end inference for predicting eye movement and gaze direction.

In some embodiments, PMD (Phase Measuring Deflectometry) detection may be implemented by utilizing the approximately spherical reflective characteristics of the corneal/scleral surface of the eye.

The single-exposure active encoded illumination and imaging decoding achieves sub-pixel accuracy. Metasurface optical element is employed to multiplex phase/polarization generation (0°/90°/RCP/LCP or any orthogonal combination), producing four orthogonal polarization states corresponding respectively to four-phase-shift (0°/90°/180°/270°) sinusoidal fringe encoded illumination. Corresponding polarization imaging decoding is performed, where pixelated four-channel polarization state imaging (0°/90°/RCP/LCP) respectively captures the reflected images of the four-phase-shift (0°/90°/180°/270°) sinusoidal fringes. The PMD calculation and reconstruction method is configured to perform phase extraction and phase unwrapping on the four-channel independent polarization-state phase-shift images, thereby accurately reconstructing the 3D surface profile of the eye for eye movement/gaze direction estimation.

In some embodiments, metasurface optical element is employed to multiplex phase/polarization generation (0°/45°/90° combination), generating 3 orthogonal polarization states corresponding respectively to 3-phase-shift (−120°/0°/120°) sinusoidal fringe encoded illumination.

In some embodiments, one or more illumination components at spatial locations integrate a light homogenizer and a structured pattern projector, and are physically isolated and multiplexed. The integrated illumination component may be independently switchable or addressable controlled to utilize either the light homogenizer or the structured pattern projector according to different scenarios. The structured pattern projector actively encodes illumination patterns and is configured with transmissive-type metasurface optical element that modulate wavefront phase/amplitude to generate structured frequency/periodic orthogonal sinusoidal fringes, as well as far-field projection patterns such as dot or line grids, Placido rings, etc., for extracting corresponding eye surface profile image.

The phase/amplitude profile distribution of the metasurface optical element is configured with a machine/deep learning model driven.

The image is captured via multiplexed imaging component and is further processed to generate 3D depth information, thereby enabling the detection of 3D eye movement/biometrics/gaze direction based on the 3D model.

In some embodiments, far-field projection patterns such as Placido rings may be utilized for ocular health monitoring and analysis, including dry eye severity grading. A normal tear film exhibits continuous striae without localized interruptions; mild cases present with partial loss of tear film striae, while severe cases demonstrate extensive non-striated areas (corresponding to a tear break-up time (BUT) of less than 5 seconds).

In some embodiments, the eye-tracking system may be configured as a lensless imaging system integrated with a deep learning neural network. For instance, a wavefront phase-encoded metasurface optical element is directly coupled to an on-chip image sensor to generate corresponding phase-encoded point spread function (PSF) intermediate image data. This PSF intermediate image data may be phase-decoded by a lightweight machine/deep learning model to achieve end-to-end predictive inference of eye movements, biometrics, and gaze direction.

The wavefront phase-encoded metasurface optical element may be configured to generate point spread functions (PSFs) with various sub-region patterns. The PSF may be defined as a spiral, quadratic spherical, cubic, or higher-order polynomial aspherical shape, among others. Furthermore, the wavefront phase-encoded metasurface optical element may be configured with a machine/deep learning model to achieve end-to-end computational imaging reconstruction of multi-functional target images, such as 3D or EDoF images.

In some other embodiments, the eye-tracking system may be configured as a directly optically coupled, on-chip integrated optical processor, enabling low-latency real-time microsecond-level (μs) optical parallel computing with microwatt-level (μW) power consumption.

The optical processor may be implemented as a metasurface optical neural network processor, which performs specified computational or inference tasks for 3D eye movement/gaze direction determination through the propagation and diffraction of a series of structured subwavelength metasurfaces. Without requiring any photoelectric conversion or preprocessing of the input information, the metasurface optical neural network processor directly manipulates all encoded optical information, including the spatial phase and amplitude, polarization, spectrum, and orbital angular momentum (OAM) of the input wave. These optical degrees of freedom may also be optically multiplexed to enhance parallel processing capabilities.

In some implementations, the metasurface optical neural network processor may be configured using optical elements such as subwavelength metasurfaces or tunable/reconfigurable intelligent metasurfaces.

In other implementations, a complex-valued optical neural network may be employed to process complex optical field phase and amplitude information. The unit cell, serving as the fundamental building block of the complex-valued optical neural network, functions by modulating the complex phase shift and transmittance of light waves passing through the subwavelength metasurface. Specific values of the complex phase shift and transmittance may be obtained by training the optical neural network parameters through deep learning algorithms—such as forward propagation, gradient descent, and error backpropagation—simulated on an electronic computing platform. For example, the propagation of light waves through multi-layer metasurface optical elements may be modeled using the Rayleigh-Sommerfeld diffraction formula (angular spectrum method simulation), where each metasurface optical layer functionally corresponds to a neuron layer in the complex-valued optical neural network.

Once all complex phase shift parameters are acquired, corresponding optical neural network models may be physically implemented using metasurface optical fabrication techniques, resulting in the physical realization of a metasurface optical neural network.

Optical neural network is inherently capable of performing universal linear transformation operators, such as linear operations, discrete Fourier transform (DFT), and permutation operations, among others.

Nonlinear activation function (ReLU/Sigmoid/Softmax etc.) may be physically realized through approaches such as employing nonlinear optical materials, saturable absorbers, or electro-optic effect-based materials.

Tunable intelligent metasurface optical components implement optical reconfigurability, enabling dynamic adjustment of optical neural network parameters. This programmability may be physically implemented using phase-change materials or spatial light modulators (SLMs), among other technologies.

In practical applications, certain embodiments may exhibit mechanical mounting misalignments, such as angular deviations in the principal optical axis of the imaging and/or illumination component. Nevertheless, these errors do not affect the inherent physical optical characteristics of the imaging and/or illumination component, and are only manifested as a corresponding variation in the extent of the region of eyebox (Reyebox) toward the object plane of the eye.

In some embodiments, an optical window element, such as a protective window or a filter window, may be supplemented to the imaging component and/or the illumination component, without affecting the inherent physical optical characteristics of the aforementioned imaging component and/or illumination component.

In some embodiments, illumination light source (e.g., LED/VCSEL) and/or image sensor (photoelectric sensor, etc.) is monolithically integrated with metasurface optical element using full-flow semiconductor manufacturing processes, wafer-level optics (WLO), or planar optical processes. This integration achieves nanoscale-accuracy pixel registration and optical axis alignment, ultimately being packaged as a photonic integrated circuit-based system-on-chip (PSoC).

In some examples, an illumination component may comprise one or more materials (e.g., one or more high-refractive-index materials), such as one or more semiconductors. In some examples, nanostructures may comprise high-refractive-index materials, such as semiconductors or dielectric materials. In some examples, the refractive index of the high-refractive-index material (from the illumination wavelength of the light source) is greater than 2, and in some examples may be approximately 3 or greater. In some examples, nanostructures or other metamaterial components may comprise materials possessing an energy bandgap larger than the photon energy emitted by the light source. In some examples, nanostructures or other metamaterial components may comprise one or more materials, such as arsenide semiconductors (e.g., GaAs, AlAs, AlxGa1-xAs), phosphide semiconductors (e.g., GaP, InxGa1-xP), nitride semiconductors (e.g., GaN, InN, AlN), oxides (e.g., titanium oxide such as TiO₂, aluminum oxide (sapphire), etc.), other III-V semiconductors, or other II-VI materials.

In some examples, the optics utilized in the imaging system and/or illumination system may be geometric, reflective, refractive, polarized, diffractive, and/or holographic, as would be understood of one of ordinary skill in the art, and may use any one or more of macro-optics, micro-optics, and/or nano optics. In some examples, the optics utilized in the imaging system and/or illumination system may include optical polymers, plastic, glass, transparent wafers (e.g., Silicon Carbide (SiC) wafers), amorphous silicon, SiliconOxide (SiO2), Silicon Nitride (SiN), Titanium Oxide (TiO), optical nylon, carbon-polymers, and/or any other transparent materials used for such a purpose, as would be understood by one of ordinary skill in the art.

Furthermore, the use of dynamically tunable metasurface optical elements in all embodiments enables reconfigurable and programmable optical functionalities via phase-change materials (e.g., GST), liquid crystals, electro-optic effects, or mechanical strain.

The traditional metasurface optical element design process begins with full-wave simulation of meta-atom unit cells. The period and angle of incidence are determined by requirements, generating a multi meta-atom library with phase delay covering the 0-2π range. Subsequently, the metasurface optical elements are constructed from this atom library, and full-wave simulations (e.g., RCWA, FDTD, FEM, etc.) are used to simulate the performance of the metasurface optical elements.

With the development and application of AI for Science, end-to-end solutions based on machine learning represent a major future direction. The core workflow includes:

### (1) Data Preparation

Parametric Modeling:
Define design variables (e.g., nanopillar diameter, rotation angle, lattice constant, etc.).
Generate datasets of parameter combinations (Latin Hypercube Sampling, random sampling).
Electromagnetic Response Simulation:
Use FDTD (Lumerical/MEEP) or FEM (COMSOL) to calculate transmission/reflection spectra and phase delay.
Target response: e.g., 2π phase coverage at specific wavelengths, polarization conversion efficiency.

### (2) Model Construction

Forward Model (Forward Prediction):
Input: Structural parameters; Output: Optical response (phase/amplitude spectra).
Common models:
Deep Neural Network (DNN): Uses fully connected networks to fit nonlinear mappings.
Convolutional Neural Network (CNN): Processes graphical structures (e.g., pixelated metasurface topology images).
Graph Neural Network (GNN): Handles irregular unit arrays.
Inverse Design Model:
Input: Target optical response; Output: Optimal structural parameters.
Methods:
Generative Models: VAE, GAN to generate structures satisfying the target response.
Conditional Generation: cGAN generates structural images based on the target response.
Embedded Optimizer: Uses the forward model as a surrogate, combined with gradient descent/evolutionary algorithms for iterative optimization.

### (3) Physical Constraint Integration

Hard Constraint Embedding:
Symmetry constraints: Enforce symmetry during data generation or within the network architecture.
Fabrication constraints: Add projection operations (e.g., threshold truncation) to the output layer.
Soft Constraints (Loss Function):
Add regularization terms.
Physical consistency loss: e.g., Maxwell's equation residuals.

### (4) Optimization Strategies

Surrogate Model-Accelerated Optimization:
Use a trained forward model as a substitute for simulators, combined with Bayesian Optimization (BO) for efficient global optimum search.
End-to-End Optimization:
Directly use optical performance targets (e.g., focusing efficiency) as the loss function, and backpropagate to update structural parameters.

The application of machine learning in metasurface optical design is rapidly transforming this field, enabling the design of structures with unprecedented complexity and performance optimization.

Future trends in machine learning for metasurface design lie in the deep integration of physical knowledge with AI, along with the construction of automated experimental closed-loop systems, thereby providing a core design engine for metasurface optical elements.

In specific embodiments, it should be understood that the terms Reyebox (Eye Box) and the corresponding FOVi/FOVr (Field of View), FOIi/FOIr (Field of Illumination) serve as unified, normalized, generalized expressions, which include defined directionality and sign conventions.

The system is defined relative to a predetermined Z-axis eye relief distance (Rrelief) and an XY-axis rectangular eye box (Reyebox) with dimensions Reyebox_x and Reyebox_y. Correspondingly, the incident and exit fields of view (FOVi/FOVr), with their X and Y components (FOVi_x/FOVi_y, FOVr_x/FOVr_y), and the incident and exit field of illumination (FOIi/FOIr), with their X and Y components (FOIi_x/FOIi_y, FOIr_x/FOIr_y), are all characterized by their specific distributions along the X and Y axes.

In response to the predefined Z-axis Rrelief and the XY-axis Reyebox possessing a constructed radialized circular area range (Reyebox_r=(Reyebox_x²+Reyebox_y²)\hat{ }½), the corresponding FOVi (FOVi_r)/FOVr (FOVr_r) and FOIi (FOIi_r)/FOIr (FOIr_r) exhibit a radialized directional distribution.

The embodiments described in this application employ unified generalized expressions solely for the concise purpose of explaining the principles. These descriptions are not intended to be exclusive or to limit the specific configurations of embodiments to a single interpretation.

For example, for the sake of simplicity, the eye relief in a head-mounted optical projection display system is defined as being equal to the vertical normal distance (Rrelief) between the principal optical axis of the imaging or illumination component and the object plane of the eye. However, it should be noted that in some practical embodiments, this vertical normal distance from the center of the respective module to the eye's object plane may actually be greater than or less than the defined eye relief.

Similarly, no restriction is imposed regarding the alignment of the imaging and illumination components. The vertical normal distance between the principal optical axis of the illumination component and the eye's object plane may be either equal to or different from that of the imaging component.

As an example, in some embodiments, the vertical normal distance for the illumination component's principal optical axis may be greater than that of the imaging component.

Furthermore, for the sake of simplicity in explanation, the eye box is defined as being equal to the bounding box of the effective area on the eye's object plane that is utilized by either the imaging or illumination component (Reyebox). However, in practical embodiments, the actual effective area on the eye's object plane for either function may be designed to be larger or smaller than this nominal eye box.

Similarly, no restriction is made requiring that the effective areas for the imaging and illumination components on the eye's object plane must be the same; they may be different. For instance, in some implementations, the illumination component's effective area on the eye's object plane may be larger than that of the imaging component.

Furthermore, the parameters mentioned including but not limited to Rrelief, Reyebox, their corresponding FOVi/FOVr and FOIi/FOIr, the NIR/SWIR wavelengths used for imaging, and the types of illumination source are not to be narrowly interpreted as limiting the configuration of specific embodiments.

While various inventive embodiments have been described and illustrated herein, those of ordinary skill in the art will readily envision a multitude of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is therefore to be understood that the foregoing embodiments are presented by way of example only and that, within the scope of the appended claims and equivalents thereto, inventive embodiments may be practiced otherwise than as specifically described and claimed.

Moreover, it is to be understood that all definitions, as defined and used herein, shall govern and take precedence over dictionary definitions, definitions in documents incorporated by reference, and/or the ordinary meaning of the defined terms.

Accordingly, the claims are not limited to the specific terminology used in the descriptions themselves and may be implemented in a variety of variant forms.

Furthermore, the content of this application document, including the description and drawings-comprising but not limited to elements such as parameter data, geometric proportions, directional/sign conventions, structural stacking relationships, relative physical spatial relationships, physical-logical coupling relationships, and narrow inferences or deductions based on the content-shall not serve as the basis for exclusive or limiting definitions and are to be treated as limited examples only. Implementation methods that constitute extensions, variants, or equivalents based on the generalized principles of the invention shall be deemed to fall within the scope of protection of this application.

What is claimed is:

1. An eye tracking system for a head-mounted device, comprising: an imaging component, and an illumination component;
wherein the imaging component is configured to optically focus light from an object plane of an eye onto an image plane of an image sensor; and
the illumination component is configured to optically project light from an illumination source onto the object plane of the eye.

2. The eye tracking system according to claim 1, wherein:
the imaging component is configured with a principal optical axis referenced to the object plane of the eye;
the imaging component is further configured with a predetermined incident field of view and an associated exit field of view;
the incident field of view is configured to be asymmetrically distributed relative to the principal optical axis;
the exit field of view is configured to be symmetrically distributed relative to the principal optical axis;
the incident field of view is greater than or equal to the exit field of view; and
the imaging component is further configured with an imaging angle-encoded mapping for optical relay-coupled imaging.

3. The eye tracking system according to claim 2, wherein:
the imaging angle-encoded mapping is configured with at least one of
i) a linear wavefront phase modulation function,
ii) an optical conjugation,
iii) an optical coupling from an incident angle with an asymmetric distribution at the object plane, to an exit angle with a symmetric distribution at the image plane;
iv) a physical relationship of geometric optical imaging characteristic between the object plane and the image plane, and
v) an optical angular compression from the incident field of view to the exit field of view.

4. The eye tracking system according to claim 2, wherein:
the optical relay-coupled imaging is configured to enable image-space telecentricity with an entrance aperture near a front focal plane of an object space.

5. The eye tracking system according to claim 1, wherein:
the illumination component is configured with a principal optical axis referenced to the object plane of the eye;
the illumination component is further configured with a predetermined incident field of illumination and an associated exit field of illumination;
the incident field of illumination is configured to be symmetrically distributed relative to the principal optical axis;
the exit field of illumination is configured to be asymmetrically distributed relative to the principal optical axis;
the incident field of illumination is greater than or equal to the exit field of illumination, or the incident field of illumination is less than or equal to the exit field of illumination; and
the illumination component is further configured with an illumination angle-encoded mapping for optical coupling projection.

6. The eye tracking system according to claim 5, wherein:
the illumination angle-encoded mapping is configured to establish an optical coupling from the incident field of illumination to the exit field of illumination relative to the principal optical axis;
the illumination angle-encoded mapping is further configured to encode and map an incident angle of a beam with symmetric distribution from the illumination source to a corresponding exit angle of the beam with asymmetric distribution at the object plane of the eye;
the illumination angle-encoded mapping is configured with the incident angle of the beam corresponding to a projected optical radiant power and the associated exit angle of the beam corresponding to a projected area on the object plane of the eye.

7. The eye tracking system according to claim 5, wherein:
the illumination angle-encoded mapping is configured to establish an optical characteristic relationship of a far field illumination irradiance profile distribution with a homogenized pattern or a structured pattern on the object plane based on an illumination source radiation model.

8. The eye tracking system according to claim 7, wherein:
the optical characteristic relationship of the far field illumination irradiance profile distribution with the homogenized pattern is configured with a constant proportional between the projected optical radiant power and the projected area on the object plane of the eye; and
the optical characteristic relationship of the far field illumination irradiance profile distribution with the structured pattern is further configured with a corresponding profile distribution function between the projected optical radiant power and the projected area on the object plane of the eye.

9. The eye tracking system according to claim 1, further comprising:
a controller configured to synchronize the imaging component with the illumination component.

10. The eye tracking system according to claim 9, wherein:
the controller is configured with an imaging parameter configuration;
the imaging parameter configuration, comprising:
a synchronized illumination-imaging period T;
an imaging frequency FI of the image sensor,
an exposure time TI of the image sensor,
an illumination frequency FR of the illumination source,
an activation time TR of the illumination source, and
a radiant intensity IR of the illumination source;
the imaging frequency FI of the image sensor is configured to be at least twice the illumination frequency FR of the illumination source, FI≥2*FR;
the synchronized illumination-imaging period T is configured to be 1/FR, T=1/FR;
the activation time TR of the illumination source is synchronized with and equal to the exposure time TI of the image sensor, TR=TI;
a duty cycle TR*FR is generated in response to the illumination source;
the imaging parameter configuration is adapted to maintain constant during the synchronized illumination-imaging period.

11. The eye tracking system according to claim 10, wherein:
the imaging parameter configuration is adapted in response to an ambient-illuminance or irradiance level measured by an ambient-light detector;
the exposure time TI of the image sensor has a linear or nonlinear negative correlation with the ambient-illuminance or irradiance level; and
the radiant intensity IR of the illumination source has a linear or nonlinear positive correlation with the ambient-illuminance or irradiance level.

12. The eye tracking system according to claim 10, wherein:
the controller is further configured to capture a paired image frame in synchronization with alternating activation and deactivation of the illumination source during the synchronized illumination-imaging period.

13. The eye tracking system according to claim 10, wherein:
the controller is further configured to have a motion displacement of less than a predetermined pixel shift on the image plane during the synchronized illumination-imaging period.

14. The eye tracking system according to claim 12, wherein:
the controller is further configured to perform image fusion denoising based on the paired image with at least one of a manually engineered model, and a lightweight deep learning model.

15. The eye tracking system according to claim 9, wherein:
the illumination component is further configured to project at least one polarization state onto the eye,
the imaging component is further configured to capture an image using the image sensor that is sensitive to at least one corresponding polarization state;
the controller is further configured to generate at least one combination of parallel and orthogonal polarization states, synchronize timing and process a polarization intensity data from the image;
the polarization intensity data is configured with at least one of
a cross-reference feature defined as a pattern modality of a corneal polarization interference intensity, and
a dynamic-reference feature defined as a dynamic relational characteristic generated from eyeball motion;
the cross-reference feature or dynamic-reference feature is configured to characterize at least one of a three-dimensional eye movement, and an ocular physiological state.

16. The eye tracking system according to claim 15, wherein
the controller is configured with a lightweight deep learning model to perform end-to-end predictive inference for outputting at least one of the three-dimensional eye movement, and the ocular physiological state.

17. The eye tracking system according to claim 15, wherein
the controller is further configured to perform feature fusion based on the polarization intensity data with at least one of a manually engineered model and a lightweight deep learning model.

18. An eye tracking apparatus for a head-mounted device, comprising: an imaging component and an illumination component;
the imaging component comprising: an imaging angle-encoded mapping metasurface optical element, a metasurface lens or a wafer-level optics (WLO) imaging lens, and an image sensor;
the illumination component comprising: an illumination angle-encoded mapping metasurface optical element and an illumination source.

19. The eye tracking apparatus according to claim 18, wherein:
the imaging angle-encoded mapping metasurface optical element is configured to be coaxial with a principal optical axis of the metasurface lens or the WLO imaging lens, and to enable an identical field of view with symmetric distribution;
the imaging angle-encoded mapping metasurface optical element is configured to encode and map an incident angle of a beam with asymmetric distribution from an object plane of an eye to an exit angle of the beam with symmetric distribution at an image plane of the image sensor, and to optically relay the exit angle of the beam to the metasurface lens or the WLO imaging lens;
the metasurface lens or the WLO imaging lens is configured to focus the beam with the exit angle onto the image plane;
the imaging angle-encoded mapping metasurface optical element is configured to serve as an entrance aperture near a front focal plane of an object space for image-space telecentricity.

20. The eye tracking apparatus according to claim 18, wherein:
the illumination angle-encoded mapping metasurface optical element is configured to encode and map an incident angle of a beam with symmetric distribution from the illumination source to an exit angle of the beam with asymmetric distribution at an object plane of an eye;
the illumination angle-encoded mapping metasurface optical element is configured with the incident angle of the beam corresponding to a projected optical radiant power and a corresponding exit angle of the beam corresponding to a projected area on the object plane;
the illumination angle-encoded mapping metasurface optical element is configured to establish an optical characteristic relationship of a far field illumination irradiance profile distribution with a homogenized pattern or a structured pattern on the object plane based on an illumination source radiation model;
the optical characteristic relationship of the far field illumination irradiance profile distribution with the homogenized pattern is configured with a constant proportional between the projected optical radiant power and the projected area on the object plane of the eye; and
the optical characteristic relationship of the far field illumination irradiance profile distribution with the structured pattern is configured with a corresponding profile distribution function between the projected optical radiant power and the projected area on the object plane of the eye.
